(19) United States
(12) Patent Application Publication
(10) Pub. No.: US 2024/0273449 A1
(43) Pub. Date: Aug. 15, 2024

(54) SYSTEM AND METHOD FOR DRY CLEANING/LAUNDRY LOGISTICS

(71) Applicant: Juliette Inc., New York, NY (US)

(72) Inventor: Rechelle Balanzat, New York, NY (US)

(73) Assignee: Juliette Inc., New York, NY (US)

(21) Appl. No.: 18/109,903

(22) Filed: Feb. 15, 2023

(51) Int. Cl. G06Q 10/08; G06Q 10/0639

(52) U.S. Cl. CPC G06Q 10/08; G06Q 10/06393

(57) ABSTRACT

A computer program may provide, using a graphical user interface of a computing device, a dashboard to a user. A computer program may display, using the graphical user interface, at least one data point having a laundry management logistic timestamp associated with data. A computer program may be configured for the user inputting, using the graphic user interface, the data from the at least one data point. A computer program may process the data from at least one data point. A computer program may analyze, using the computer program, the data having the timestamp. A computer program may be responsive to analyzing, using the computer program, to identify a sequence of laundry order information from the data having the timestamp. A computer program may execute the computer program on the sequence of the laundry order information, wherein the computer program predicting a trend associated with the laundry order information.

### FIELD OF THE EMBODIMENTS

The field of the invention and its embodiments relates to systems and methods for dry cleaning and laundry logistics, and more particularly to a computer program having a business intelligence dashboard configured for point of sale management and logistics.

### BACKGROUND OF THE EMBODIMENTS

Currently, many laundry and dry cleaning businesses manage order intake manually, which may be prone to human error. Customer details and preferences of customers are typically kept on notepads and stored in file cabinets, which makes manual searching of a customer's file time consuming. There is a wealth of customer data as it pertains to dry cleaning and laundry point of sale that is not being analyzed for optimal order tracking and/or management to facilitate customized customer experience and marketing, assembly and production management, and staff management and visibility. For example, some companies count the number of pounds of laundry washed and the number of pieces of garments dry cleaned. It would be more desirable to use this collected data to make informed business decisions. For example, determining projected ranges of pounds of clothes a business can expect to wash in a given time period may be used for a more accurate cleaning agent inventory control. In another example, a business could determine projected revenue from a select grouping of customers and plan for potential expenses accordingly.

Thus, there is a need for a historical data analysis system and method that may facilitate dry cleaning and/or laundry businesses to make more accurate projections by analyzing business trends as a whole as well as tracking day-to-day business in order to assess future plans of action.

### REVIEW OF RELATED ART

JP2020074132A is a reference providing a laundry management system that includes a POS terminal, a shop mobile terminal and a management device.

TW201344600A is a reference providing a system and a method for laundry management and delivery.

CN113313398B is a reference describing a laundry management method and system that allows users to receive real-time notifications regarding the status of their laundry and/or dry cleaning.

WO2020130572A1 and US20220141628A 1 references describe a method for providing a non-contact laundry service. The method includes numerous process steps, such as: executing a non-contact laundry service application; receiving the input, from a user, of a tariff system of a non-contact laundry service; fastening to the user's door a laundry bag, for a non-contact laundry service, into which the user puts laundry; and the user requesting a pick-up using a pick-up request button on the application.

### SUMMARY OF THE EMBODIMENTS

The present invention and its embodiments relate to a software solution for laundry and dry cleaning. In some aspects, the techniques described herein relate to a laundry and dry cleaning system having a point of sale data manager, a logistics platform, and a business intelligence dashboard for data analysis and projection model generation.

In some aspects, the techniques described herein relate to a computer program including instructions which, when the program is executed by a computer, cause the computer to carry out the steps of: providing, using a graphical user interface of a computing device, a dashboard to a user; displaying, using the graphical user interface, at least one data point having a laundry management logistic timestamp associated with data: the user inputting, using the graphic user interface, the data from the at least one data point: processing the data from the at least one data point: analyzing the data having the timestamp, using machine learning, to generate a sequence of laundry order information from the data having the timestamp: responsive to analyzing, using the computer program, to identify a predetermined portion of data from the sequence of laundry order information from the data having the timestamp; and executing the computer program on the predetermined portion of data from the sequence of the laundry order information, wherein the computer program predicting a trend associated with the laundry order information.

In some aspects, the techniques described herein relate to a computer program, further including generating, using the machine learning, a model of the trend.

In some aspects, the techniques described herein relate to a computer program, further including displaying, using the graphical user interface, a graph having data associated with the trend for order rate.

In some aspects, the techniques described herein relate to a computer program, further including displaying, using the graphical user interface, a graph having data associated with the trend for income.

In some aspects, the techniques described herein relate to a computer program, further including displaying, using the graphical user interface, a graph having data associated with the trend for order frequency.

In some aspects, the techniques described herein relate to a computer program, further including displaying, using the graphical user interface, a chart having data associated with the trend for a percentage calculated of a laundry order item for a predetermined time.

In some aspects, the techniques described herein relate to a computer program, further including displaying, using the graphical user interface, a chart having data associated with the trend for a percentage calculated of a payment method used for a laundry order item.

In some aspects, the techniques described herein relate to a computer program, further including generating, using a report module, a report.

In some aspects, the techniques described herein relate to a computer program, wherein the report is an individual report for a customer based on the quantity of orders placed in a predetermined time period and the percentage of items in the order for the predetermined time period.

In some aspects, the techniques described herein relate to a computer program, wherein the report is a monthly average order value report for a user based on the total revenue in a predetermined time period and the quantity of orders placed in the predetermined time period.

In some aspects, the techniques described herein relate to a computer-implemented method including: providing, using a graphical user interface of a computing device, a dashboard to a user; displaying, using the graphical user interface, at least one data point having a dry cleaning management logistic timestamp associated with data: the user inputting, using the graphic user interface, the data from the at least one data point: processing the data from the at least one data point: analyzing, using the computing device, the data having the timestamp; responsive to analyzing, using the computing device, identifying a sequence of dry cleaning order information from the portion of data having the timestamp; and executing the computing device on the sequence of the dry cleaning order information, wherein the computer program predicting a trend associated with the laundry order information.

In some aspects, the techniques described herein relate to a computer-implemented method, further including editing, using the graphic user interface, the data being customer details.

In some aspects, the techniques described herein relate to a computer-implemented method, further including displaying, using the graphical user interface, a graph having data associated with the trend for order rate.

In some aspects, the techniques described herein relate to a computer-implemented method, further including displaying, using the graphical user interface, a graph having data associated with the trend for income.

In some aspects, the techniques described herein relate to a computer-implemented method, further including displaying, using the graphical user interface, a graph having data associated with the trend for order frequency.

In some aspects, the techniques described herein relate to a computer-implemented method, further including displaying, using the graphical user interface, a chart having data associated with the trend for a percentage calculated of a dry cleaning order item for a predetermined time.

In some aspects, the techniques described herein relate to a computer-implemented method, further including displaying, using the graphical user interface, a chart having data associated with the trend for a percentage calculated of a payment method used for a dry cleaning order item.

In some aspects, the techniques described herein relate to a computer-implemented method, further including generating, using a report module, a report.

In some aspects, the techniques described herein relate to a computer-implemented method, wherein the report is an individual report for a customer based on the quantity of orders placed in a predetermined time period and the percentage of items in the order for the predetermined time period.

In some aspects, the techniques described herein relate to a computer-implemented method, wherein the report is a monthly average order value report for a user based on the total revenue in a predetermined time period and the quantity of orders placed in the predetermined time period.

### BRIEF DESCRIPTION OF THE DRAWINGS

FIG. 1 depicts a flow chart illustrating a customer dashboard for a system and method for dry cleaning and/or laundry logistics, according to at least some embodiments disclosed herein;

FIG. 2 depicts an illustration of a block diagram of an embodiment of a customer dashboard for a system and method for dry cleaning and/or laundry logistics system of FIG. 1, according to at least some embodiments disclosed herein;

FIG. 3 depicts a flow chart illustrating customer details for a system and method for dry cleaning and/or laundry logistics, according to at least some embodiments disclosed herein;

FIG. 4 depicts an illustration of a block diagram of an embodiment of customer details for a system and method for dry cleaning and/or laundry logistics of FIG. 3, according to at least some embodiments disclosed herein;

FIG. 5 depicts a flow chart illustrating editing customer details for a system and method for dry cleaning and/or laundry logistics, according to at least some embodiments disclosed herein:

FIG. 6 depicts an illustration of a block diagram of an embodiment of editing customer details for a system and method for dry cleaning and/or laundry logistics of FIG. 5, according to at least some embodiments disclosed herein;

FIG. 7 depicts a flow chart illustrating order history details for a system and method for dry cleaning and/or laundry logistics, according to at least some embodiments disclosed herein;

FIG. 8 depicts an illustration of a block diagram of an embodiment of order history details for a system and method for dry cleaning and/or laundry logistics of FIG. 7, according to at least some embodiments disclosed herein;

FIG. 9 depicts a flow chart illustrating analytics for a system and method for dry cleaning and/or laundry logistics, according to at least some embodiments disclosed herein;

FIG. 10 depicts a flow chart illustrating analytics for a system and method for dry cleaning and/or laundry logistics, according to at least some embodiments disclosed herein:

FIG. 11 depicts an illustration of a block diagram of an embodiment of adding an order for a system and method for dry cleaning and/or laundry logistics of FIG. 9, according to at least some embodiments disclosed herein:

FIG. 12 depicts a flow chart illustrating a pre-orders dashboard and adding a pre-order for a system and method for dry cleaning and/or laundry logistics, according to at least some embodiments disclosed herein;

FIG. 13 depicts an illustration of a block diagram of an embodiment of a pre-order dashboard for a system and method for dry cleaning and/or laundry logistics of FIG. 12, according to at least some embodiments disclosed herein;

FIG. 14 depicts an illustration of a block diagram of an embodiment of adding a pre-order for a system and method for dry cleaning and/or laundry logistics of FIG. 12, according to at least some embodiments disclosed herein:

FIG. 15 depicts a flow chart illustrating an orders dashboard and adding a pre-order for a system and method for dry cleaning and/or laundry logistics, according to at least some embodiments disclosed herein;

FIG. 16 depicts an illustration of a block diagram of an embodiment of a module for stages of an order for a system and method for dry cleaning and/or laundry logistics of FIG. 15, according to at least some embodiments disclosed herein;

FIG. 17 depicts a flow chart illustrating a draft order dashboard for a system and method for dry cleaning and/or laundry logistics, according to at least some embodiments disclosed herein;

FIG. 18 depicts a flow chart illustrating a discounts dashboard for a system and method for dry cleaning and/or laundry logistics, according to at least some embodiments disclosed herein:

FIG. 19 depicts a flow chart illustrating adding orders in an order intake dashboard for a system and method for dry cleaning and/or laundry logistics, according to at least some embodiments disclosed herein;

FIG. 20 depicts an illustration of a block diagram of an embodiment of adding orders in an order intake dashboard for a system and method for dry cleaning and/or laundry logistics of FIG. 19, according to at least some embodiments disclosed herein;

FIG. 21 depicts an illustration of a block diagram of an embodiment of an order details module for a system and method for dry cleaning and/or laundry logistics, according to at least some embodiments disclosed herein;

FIG. 22 depicts a flow chart illustrating an items module for a system and method for dry cleaning and/or laundry logistics, according to at least some embodiments disclosed herein;

FIG. 23 depicts an illustration of a block diagram of an embodiment of an items module for a system and method for dry cleaning and/or laundry logistics of FIG. 22, according to at least some embodiments disclosed herein;

FIG. 24 depicts an illustration of a block diagram of an embodiment of an items module having the ability to add an item for a system and method for dry cleaning and/or laundry logistics, according to at least some embodiments disclosed herein;

FIG. 25 depicts an illustration of a block diagram of an embodiment of an items module having the ability to edit an item for a system and method for dry cleaning and/or laundry logistics, according to at least some embodiments disclosed herein;

FIG. 26 depicts a flow chart illustrating an add-ons module for a system and method for dry cleaning and/or laundry logistics, according to at least some embodiments disclosed herein;

FIG. 27 depicts a flow chart illustrating a discounts dashboard for a system and method for dry cleaning and/or laundry logistics, according to at least some embodiments disclosed herein;

FIG. 28 depicts a flow chart illustrating a cash flow module for a system and method for dry cleaning and/or laundry logistics, according to at least some embodiments disclosed herein;

FIG. 29 depicts a flow chart illustrating an embodiment of for a cash flow module for a system and method for dry cleaning and/or laundry logistics, according to at least some embodiments disclosed herein;

FIG. 30 depicts a flow chart illustrating a cash register configured to edit a cash entry for a system and method for dry cleaning and/or laundry logistics, according to at least some embodiments disclosed herein;

FIG. 31 depicts a flow chart illustrating an embodiment of a cash register configured to add a cash entry for a system and method for dry cleaning and/or laundry logistics, according to at least some embodiments disclosed herein;

FIG. 32 depicts a flow chart illustrating a module showing a vendor listing for a system and method for dry cleaning and/or laundry logistics, according to at least some embodiments disclosed herein;

FIG. 33 depicts a flow chart illustrating a third party sign-up module for a system and method for dry cleaning and/or laundry logistics, according to at least some embodiments disclosed herein;

FIG. 34 depicts an illustration of a block diagram of an embodiment for a third party sign-up module for a system and method for dry cleaning and/or laundry logistics of FIG. 33, according to at least some embodiments disclosed herein;

FIG. 35 depicts an illustration of a block diagram of an embodiment for a third party sign-up module for a system and method for dry cleaning and/or laundry logistics, according to at least some embodiments disclosed herein;

FIG. 36 depicts a flow chart illustrating a third party login module for a system and method for dry cleaning and/or laundry logistics, according to at least some embodiments disclosed herein;

FIG. 37 depicts an illustration of a block diagram of an embodiment for a third party sign-login module for a system and method for dry cleaning and/or laundry logistics of FIG. 36, according to at least some embodiments disclosed herein;

FIG. 38 depicts an illustration of a block diagram of a forget password module for a system and method for dry cleaning and/or laundry logistics, according to at least some embodiments disclosed herein;

FIG. 39 depicts an illustration of a block diagram of an embodiment for a forget password module for a system and method for dry cleaning and/or laundry logistics, according to at least some embodiments disclosed herein;

FIG. 40 depicts a flow chart illustrating a request pickup module for a system and method for dry cleaning and/or laundry logistics, according to at least some embodiments disclosed herein;

FIG. 41 depicts an illustration of a block diagram of an embodiment for a request pickup module for a system and method for dry cleaning and/or laundry logistics of FIG. 40, according to at least some embodiments disclosed herein;

FIG. 42 depicts an illustration of a block diagram of an embodiment for a cancel pickup module for a system and method for dry cleaning and/or laundry logistics, according to at least some embodiments disclosed herein;

FIG. 43 depicts a flow chart illustrating a view orders module for a system and method for dry cleaning and/or laundry logistics, according to at least some embodiments disclosed herein;

FIG. 44 depicts an illustration of a block diagram of an embodiment for a view orders module for a system and method for dry cleaning and/or laundry logistics of FIG. 43, according to at least some embodiments disclosed herein;

FIG. 45 depicts a flow chart illustrating a profile module for a system and method for dry cleaning and/or laundry logistics, according to at least some embodiments disclosed herein;

FIG. 46 depicts an illustration of a block diagram of an embodiment for a profile module for a system and method for dry cleaning and/or laundry logistics of FIG. 45, according to at least some embodiments disclosed herein;

FIG. 47 depicts an illustration of a block diagram of an embodiment for adding address details to a profile module for a system and method for dry cleaning and/or laundry logistics, according to at least some embodiments disclosed herein;

FIG. 48 depicts an illustration of a block diagram of an embodiment for adding card payment details to a profile module for a system and method for dry cleaning and/or laundry logistics, according to at least some embodiments disclosed herein;

FIG. 49 depicts an illustration of a block diagram of an embodiment for editing personal details in a profile module for a system and method for dry cleaning and/or laundry logistics, according to at least some embodiments disclosed herein:

FIG. 50 depicts an illustration of a block diagram of an embodiment for editing address details in a profile module for a system and method for dry cleaning and/or laundry logistics, according to at least some embodiments disclosed herein;

FIG. 51 depicts an illustration of a block diagram of an embodiment for editing password details in a profile module for a system and method for dry cleaning and/or laundry logistics, according to at least some embodiments disclosed herein;

FIG. 52 depicts an illustration of a block diagram of an embodiment for editing email details in a profile module for a system and method for dry cleaning and/or laundry logistics, according to at least some embodiments disclosed herein;

FIG. 53 depicts an illustration of a block diagram of an embodiment for editing mobile number details to a profile module for a system and method for dry cleaning and/or laundry logistics, according to at least some embodiments disclosed herein;

FIG. 54 depicts an illustration of a block diagram of an embodiment accessing price list data for a system and method for dry cleaning and/or laundry logistics, according to at least some embodiments disclosed herein;

FIG. 55 depicts an illustration of a block diagram of an embodiment accessing informative data for a system and method for dry cleaning and/or laundry logistics, according to at least some embodiments disclosed herein; and

FIG. 56 depicts a flow chart illustrating a method for dry cleaning and/or laundry logistic generation.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a.” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A): in yet another embodiment, to both A and B (optionally including other elements): etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B): in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

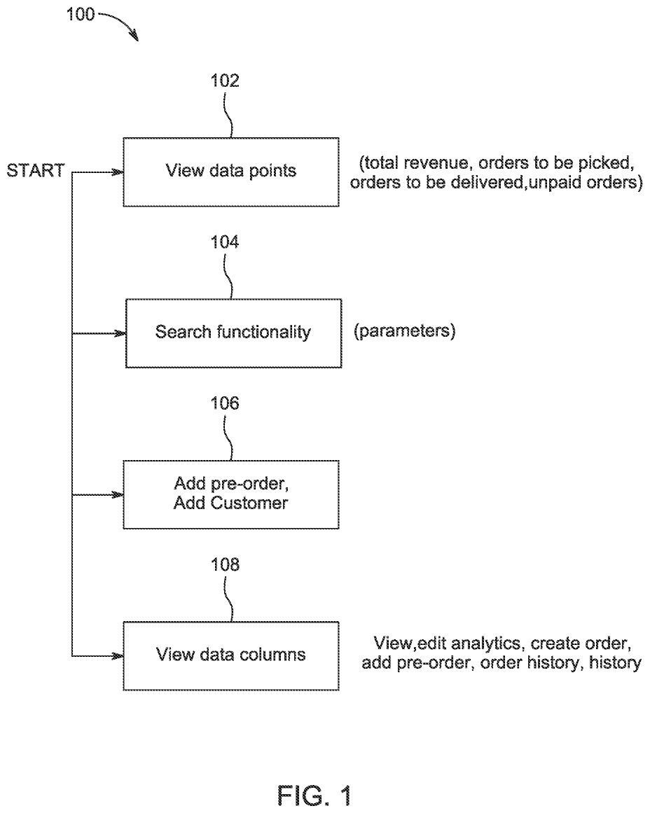

FIG. 1 depicts a flow chart illustrating a customer dashboard 100 for a system and method for dry cleaning and/or laundry logistics where cards are shown at the top of the dashboard. At 102, view data points 102 includes, but is not limited to, total revenue, orders to be picked up, orders to be delivered, and/or unpaid orders. At 104, search functionality 104 includes parameters. The columns are shown on the dashboard including, but not limited to, profile, first name, last name, mobile, email address, last four credit card digits, total sales, and latest order. Search functionality is based on all the columns shown in the dashboard. In an example a search may be made with a name and/or a date. Data may be filtered based on the columns shown on the dashboard. Data may also be filtered based on date range. At 106, pre-order data may be added and/or customer information may be added. At 108, viewing data columns provide actions possible from the dashboard including, but not limited to, view, edit, analytics, create order, add pre order, order history, and delete.

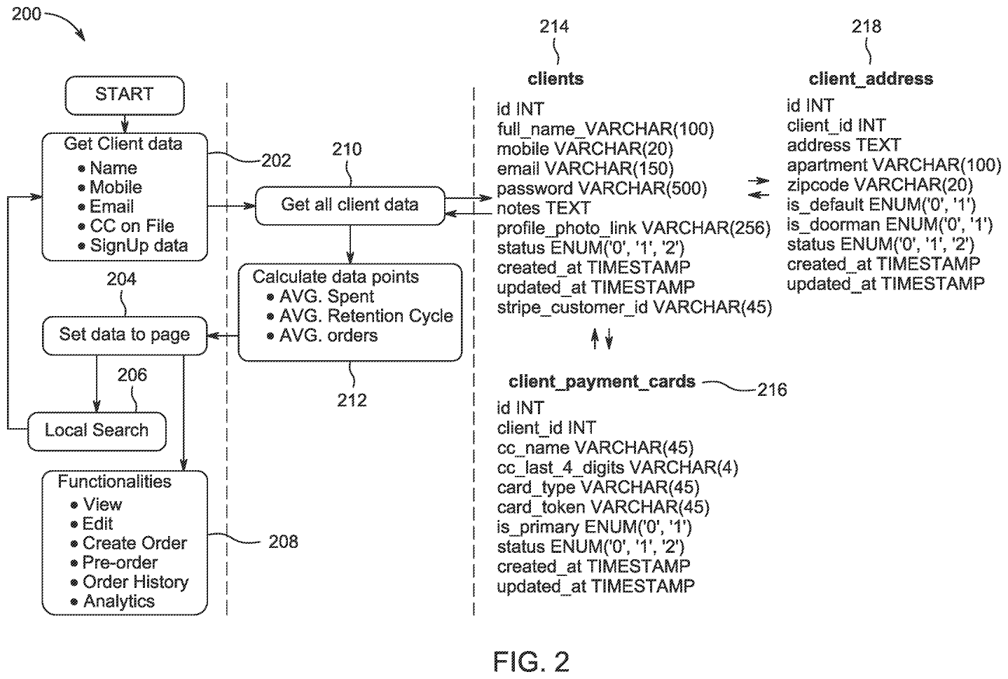

FIG. 2 depicts an illustration of a block diagram of an embodiment of customer dashboard 200 for a system and method for dry cleaning and/or laundry logistics system of FIG. 1. At 202, client data is received. It is within the scope of this invention for client data to include, but not be limited to name, mobile number, email, credit card on file, and/or sign-up date. At 210, all client data is received. At 212, data points are calculated based on the average amount spent, average retention cycle, and/or average order. At 204, set data to page. At 206, a local search may be performed. At 208, functionalities include, but are not limited to, view, edit, create order, pre-order, order history, and/or analytics. At 214, the creation of new and/or updated data of client information is timestamped. At 216, the creation of new and/or updated data of client card payments is timestamped. At 218, the creation of new and/or updated data of the client address is timestamped.

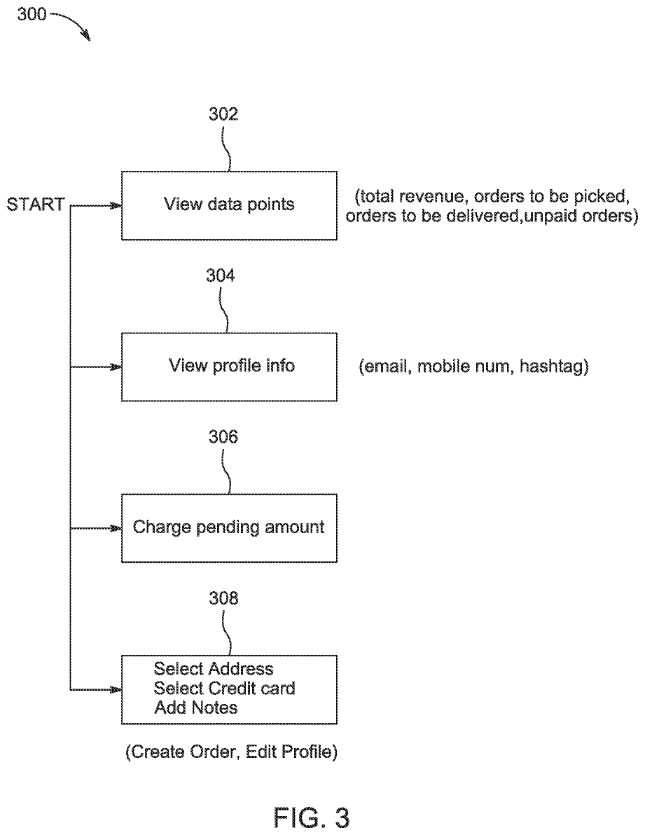

FIG. 3 depicts a flow chart illustrating customer details for a system and method for dry cleaning and/or laundry logistics, according to embodiment 300 disclosed herein. At 302, viewing data points includes, but is not limited to, total revenue, orders to be picked-up, orders to be delivered, and/or unpaid orders. A listing of API's is needed to retrieve data points for the page such as, a profile image, total orders, total amount, average order price, full name, email address, mobile number, tag, list of address when the default is preselected, a list of credit cards when the default is preselected, and/or notes. At 304, viewing profile information includes, but is not limited to, email, mobile, and/or hashtag. At 306, the pending amount is charged. The total amount pending is shown to a customer. When a user clicks on the charge icon, a payment alert box opens and a user proceeds with processing a payment. At 308, to create an order and/or edit the profile, an address may be selected, a credit card may be selected, and/or notes may be added. Search functionality is based on all the columns shown in the dashboard and may be used to search the customer data. It is within the scope of this invention for at least 20% of the screen to show a list of customers. A list of customers will display a customer first name, last name, and/or profile. The actions made possible from this page include, but are not limited to, navigating back to the customers list and/or creating an order.

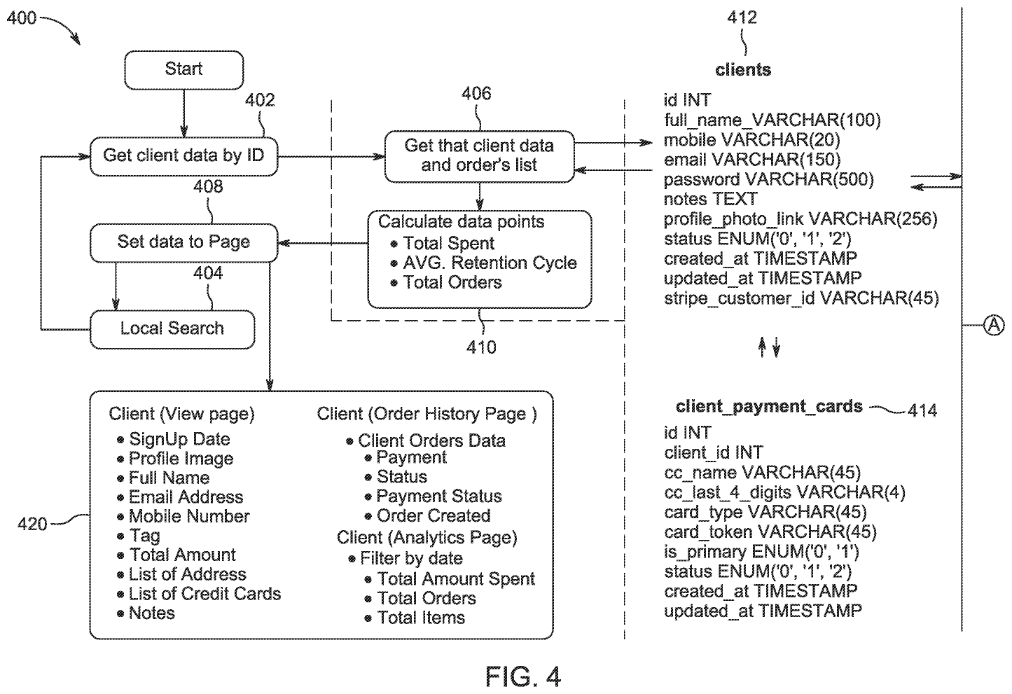

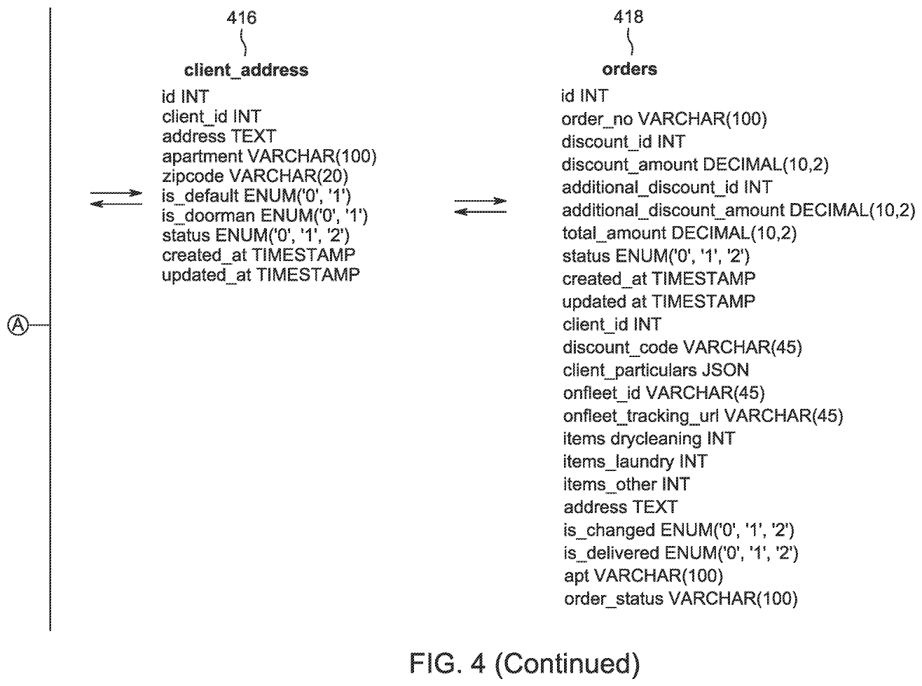

FIG. 4 depicts an illustration of a block diagram of embodiment 400 of customer details for a system and method for dry cleaning and/or laundry logistics of FIG. 3. At 402, client data is retrieved by ID. At 406, the client data and order's list is retrieved. At 410, data points are calculated such as the total spent, average retention cycle, and/or total orders. At 408, data is set to a page. At 404, a local search may be performed to retrieve client data by ID. At 420, a client view page shows information including, but not limited to, sign-up date, a profile image, full name, email address, mobile number, a tag, a total amount, a list of addresses, a list of credit cards, and/or notes. A client order history page displays client orders data including, but not limited to, payment, status, payment status, and/or order created. A client analytics page displays information filtered by date such as the total amount spent, the total orders, and/or total items. At 412, client information is created and updated with a timestamp. At 414, client payment card information is created and updated with a timestamp. At 416, client address information is created and updated with a timestamp. At 418, order information is created and updated with a timestamp.

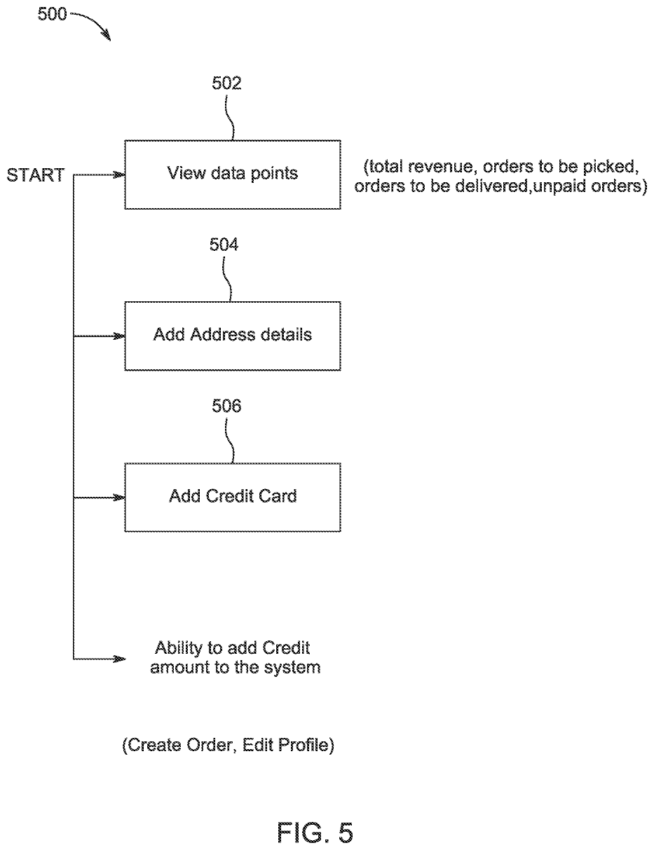

FIG. 5 depicts a flow chart illustrating editing customer details for a system and method for dry cleaning and/or laundry logistics, according to embodiment 500 disclosed herein. At 502, a list of API's are needed to edit data points for this page such as, total revenue, orders to be picked-up, orders to be delivered, and/or unpaid orders. A list of API's include, but are not limited to, a profile image, a first name, a last name, a mobile number, an email address, a tag, notes, an address selection, a credit card selection, and/or a total credit. At 504, the ability for a user to add a new address when an icon is selected next to the address field of the user interface. An alert message will be displayed to a user through the user interface showing details including, but not limited to, apartment number, zip code, address, and/or set as default checkbox. At 506, the ability for a user to add a new credit card when an icon is selected next to the credit card field. An alert message will be displayed to a user through the user interface showing details including, but not limited to, name on the card, card number, expiration number, CVV, and/or set as default checkbox. An ability for the system to charge a user for the outstanding balance due is accomplished by displaying the total amount pending for a user. When the user selects the charge button of the user interface of the system, a payment alert indicator is displayed to a user and the user is able to proceed with the payment process. Some actions possible from this page, include, but are not limited to, moving back to a customer list and/or creating an order.

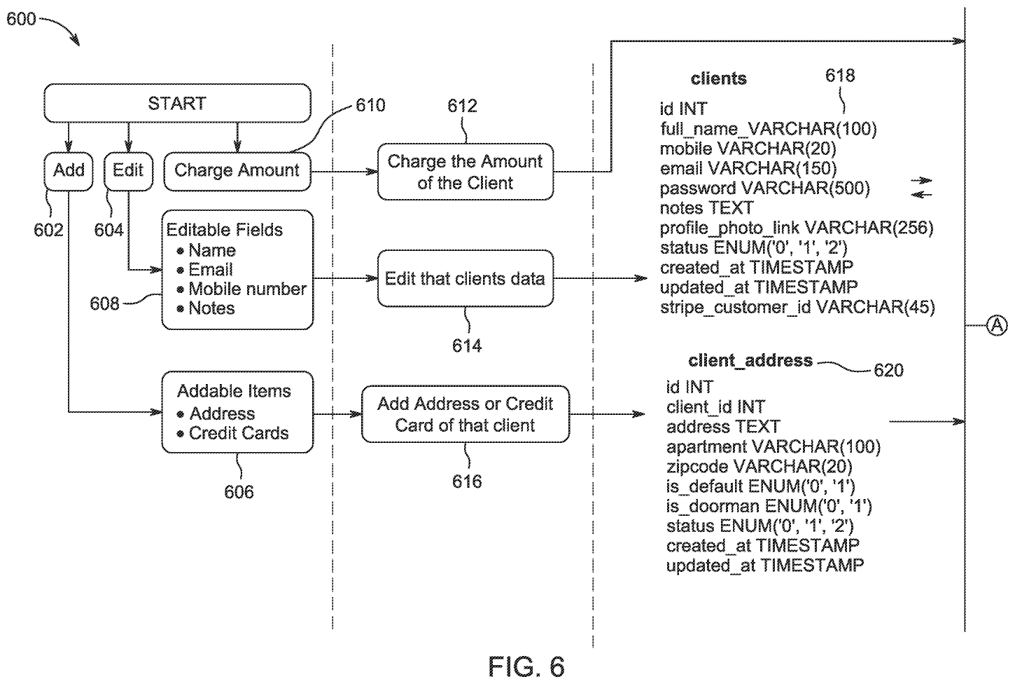

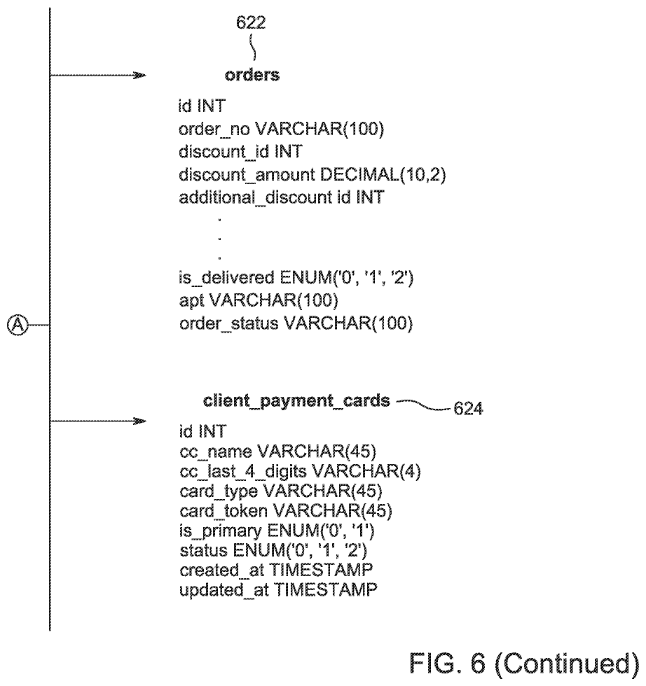

FIG. 6 depicts an illustration of a block diagram of embodiment 600 of editing 604 customer details for a system and method for dry cleaning and/or laundry logistics of FIG. 5. At 608, editable fields include, but are not limited to, name, email, mobile number, and/or notes. At 614, client data is edited. At 618, client information is created and updated with a timestamp. At 602, a user may add addable items. At 606, addable items include, but are not limited to, address and/or credit cards. At 616, the address or credit card of a client is added. At 620, client address information is created and updated with a timestamp. At 624, client payment card information is created and updated with a timestamp. At 610, charge amount is selected. At 612, the amount of a client is charged. At 622, discount amount, delivery information, and/order status is displayed.

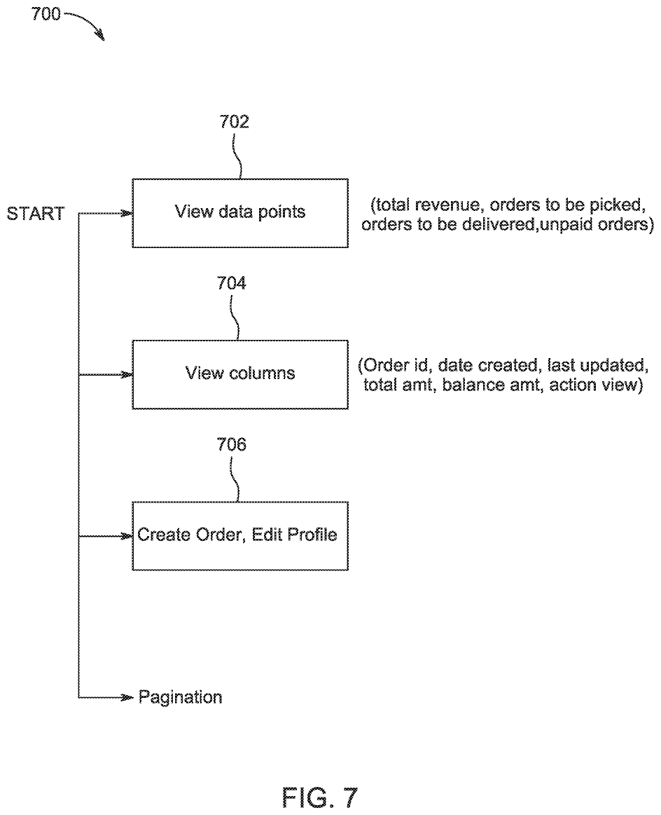

FIG. 7 depicts a flow chart illustrating embodiment 700 of order history details for a system and method for dry cleaning and/or laundry logistics. At 702, data points may be viewed such as total revenue, orders to be picked-up, orders to be delivered, and/or unpaid orders. At 704, columns may be viewed from a display of the user interface. Some of the items listed include, but are not limited to. Order identification number, date created, last update, total amount, balance amount, and/or view action button. A user may view the order details page. At 706, a user may create an order and/or edit a profile. Users may sort the data by clicking on pagination. A predetermined number of records may be displayed to a user on the first page. This page allows a user to navigate to the customer's list and or/to create an order.

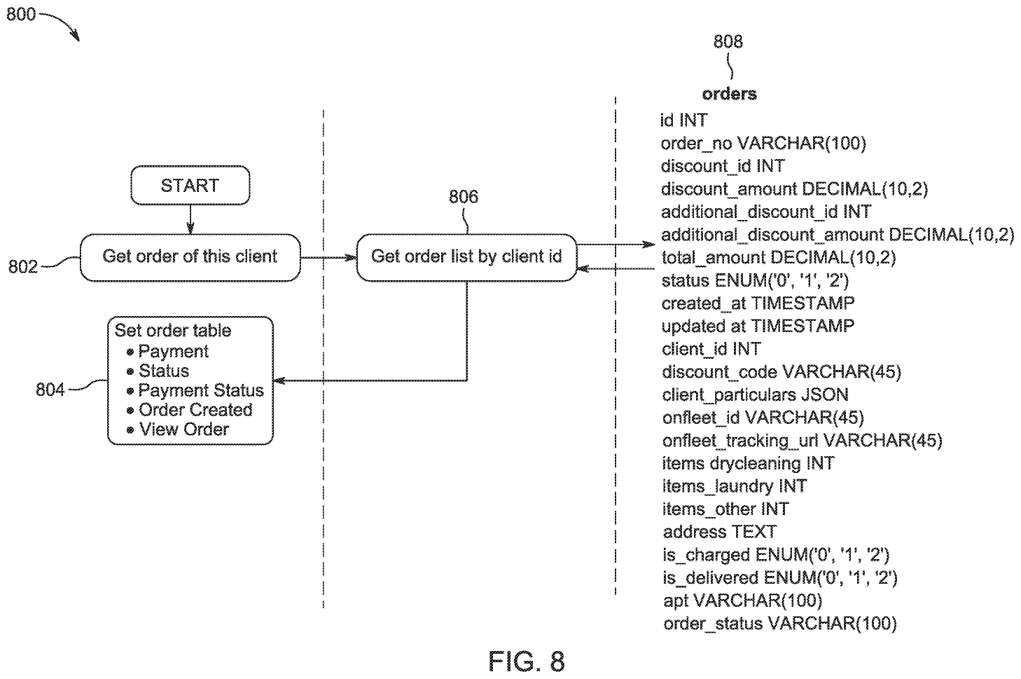

FIG. 8 depicts an illustration of a block diagram of embodiment 800 of order history details for a system and method for dry cleaning and/or laundry logistics of FIG. 7. At 802, the client order is taken. At 806, an order list is generated by the client identification number. At 804, the order table is set with information including, but not limited to, payment, status, payment status, order creation, and or viewing order. At 808, order information is displayed.

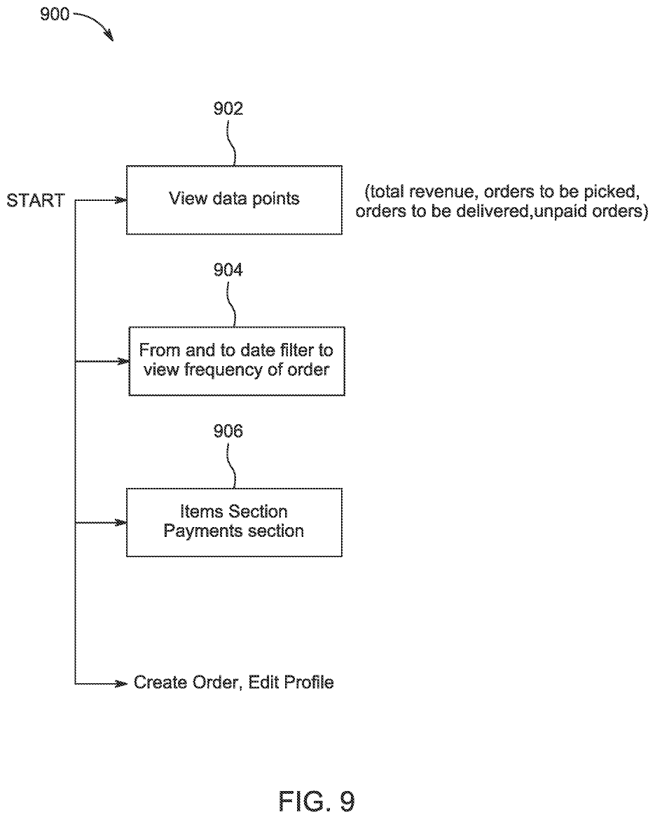

FIG. 9 depicts a flow chart illustrating analytics page 900 for a system and method for dry cleaning and/or laundry logistics. At 902, data points are viewed including, but not limited to total amount, total orders, average price, canceled orders, and/or amount to be paid. A graph is displayed to a user with order rate and income. At 904, frequency order is viewable with a from and to date filter. Data may be filtered by selecting a date range. The total number of dry cleaning items, wash and clean items, and/or alterations may be displayed to a user through user interface. At, 906, an items section and a payments section is viewable through a user interface of a display of an electronic device. The API to show data points includes, but is not limited to, signup order date, first order date, and/or latest order date. A graph for order frequency may show order information. For example, the number of orders per month. An items section pie chart may show the percentage for all the items which are tailored and/or washed with the application system application for the customer. Some of the actions possible from this page include, but are not limited to, navigation back to the customer's list, and/or create order.

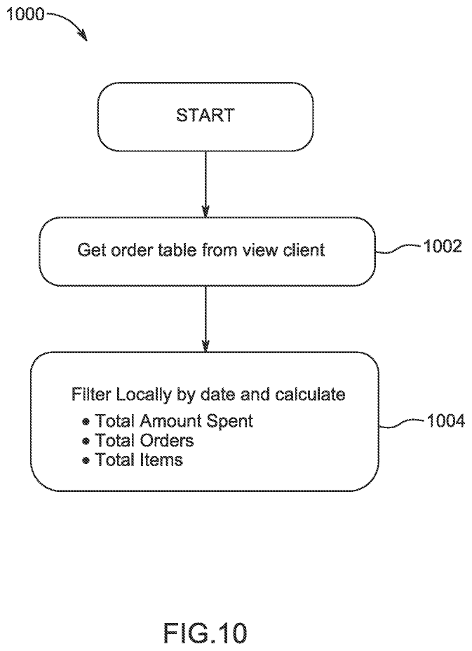

FIG. 10 depicts a flow chart illustrating analytics for a system and method for dry cleaning and/or laundry logistics, according to embodiment 1000. At 1002, an order table is received from view client. At 1004, filtering locally by date and calculating total amount spent, total orders, and/or total items.

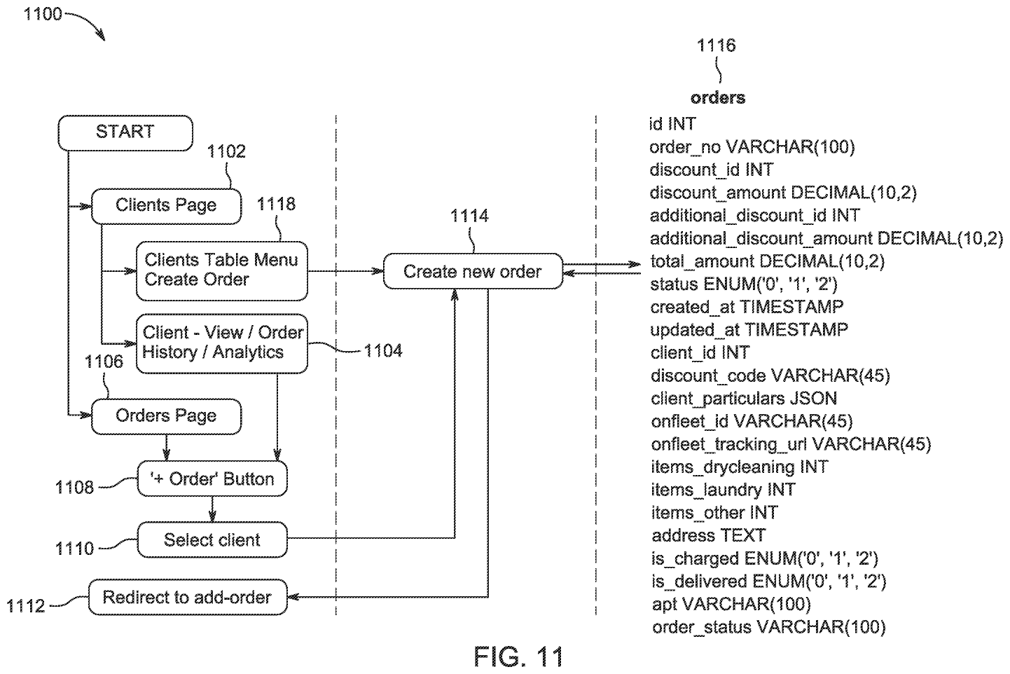

FIG. 11 depicts an illustration of a block diagram of embodiment 1100 of adding an order for a system and method for dry cleaning and/or laundry logistics of FIG. 9. At 1102, the client's page is displayed. At 1118, the client's table menu is displayed. At 1114, a user may create a new order. At 1116, the tables used to form the add-orders page are illustrated. At 1112, redirecting to add-order. At 1110, selecting a client. At, 1104, the possible actions from this page include a client viewing, order history, and/or analytics. Order intake may be enabled when for example, a garment is delivered to the store including, but not limited to, adding items, adding tags, adding notes, adding images, adding a discount, and/or charging and delivery options. At 1106, the orders page allows a user access to the add orders button at 1108. At 1110, the client is selected.

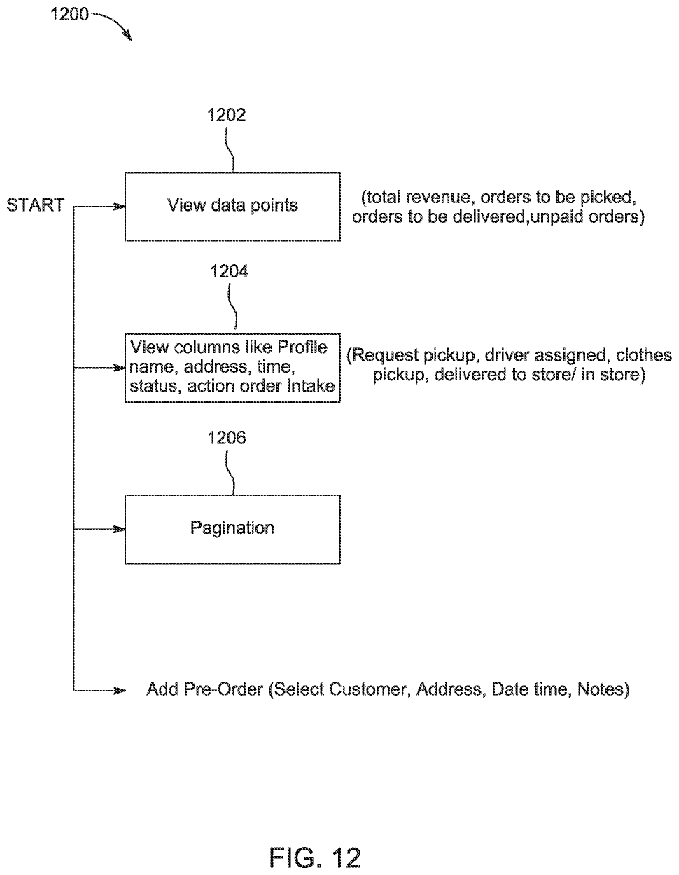

FIG. 12 depicts a flow chart illustrating a pre-orders dashboard 1200. At 1202, view data points include, but are not limited to, total revenue, orders to be picked, orders to be delivered, and/or unpaid orders. At 1204, view columns including, but not limited to, profile, name, address, time, status, action order intake. This page allows a user to request a pick-up, shows the driver assigned, clothes picked up and/or delivered to the store and/or in store. At 1206, pagination allows a user to sort the data by clicking on pagination. A pre-order may be added. The customer is selected along with the address, date, time, and/or notes. This module shows two types of requests. The first request is when the software application, for example, receives a request from the customer to pick up dirty clothes for drycleaning. The second request occurs when, for example, the customer drops off dirty clothes at the store.

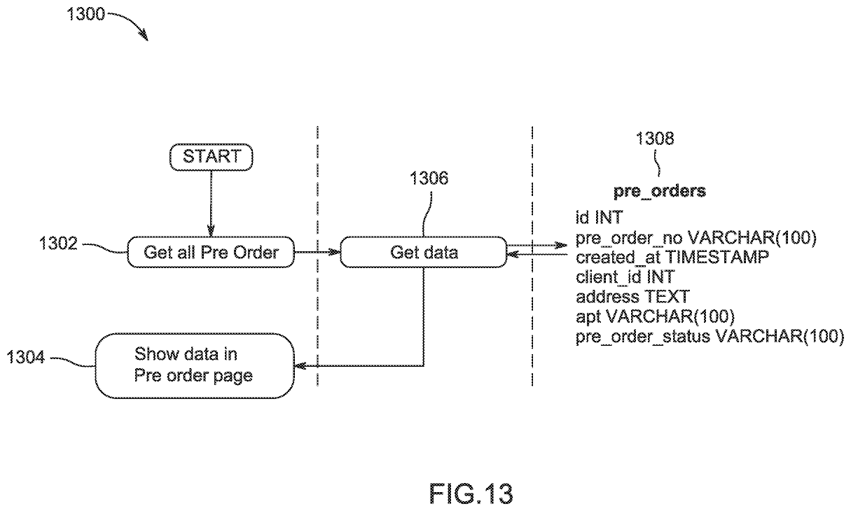

FIG. 13 depicts an illustration of a block diagram of an embodiment of pre-order dashboard 1300 for a system and method for dry cleaning and/or laundry logistics of FIG. 12. At 1302, the list of pre-orders has columns with data for profile information, name, address, time, and status. At 1304, the detailed flow of on-fleet is displayed to a user such as data for requesting a pick-up, the driver assigned, the garments to be picked-up, and/or store delivery information. At 1306, a user may retrieve data. At 1308, pre-order data is timestamped. It is within the scope of this invention for a pre-order to be added. The fields displayed on the user interface of the application include, but are not limited to, selecting customer, selecting an address, date, time, and/or notes. The actions possible from this page include, but are not limited to, order intake enabled when a garment is delivered at the store directly by the customer. A customer may download pre-orders. For example, a customer may download a report in excel format.

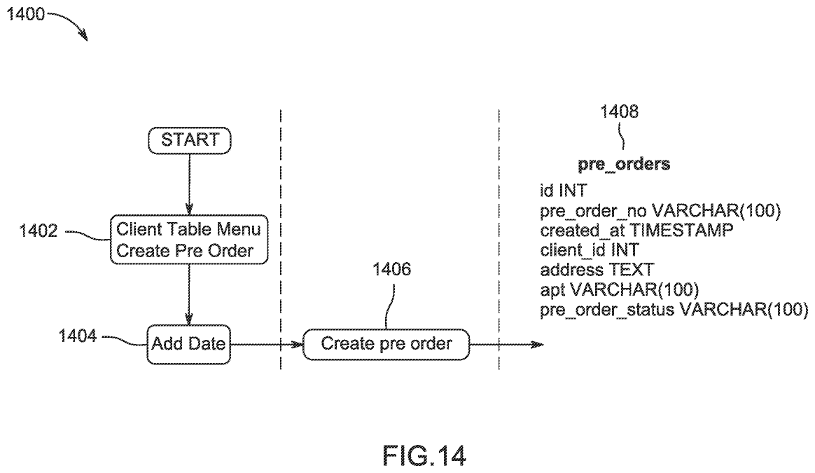

FIG. 14 depicts an illustration of a block diagram of an embodiment of dashboard 1400 for adding a pre-order for a system and method for dry cleaning and/or laundry logistics of FIG. 12. At 1402, a client may access a table menu to create a pre-order. At 1404, a date is added. At 1406, a pre-order is created. At 1408, pre-order's that are created are timestamped.

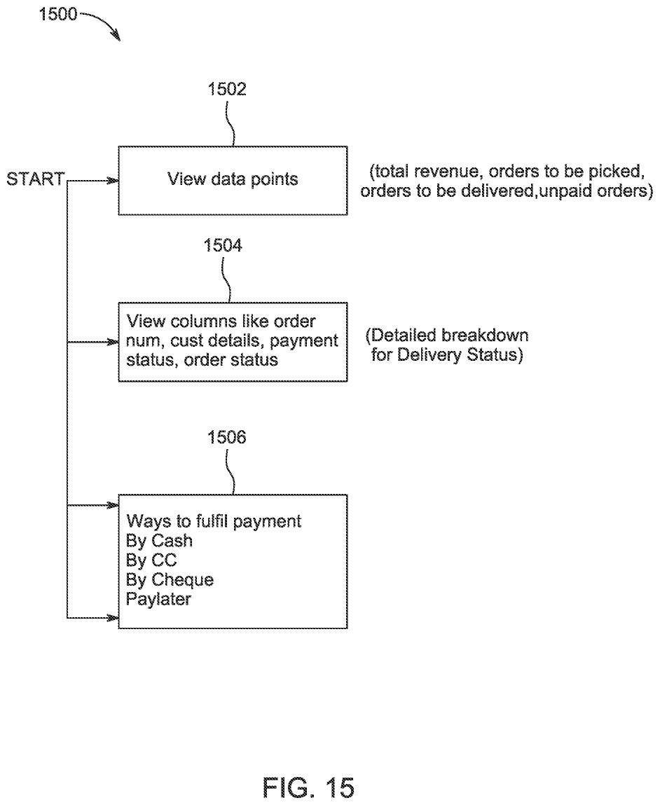

FIG. 15 depicts a flow chart illustrating orders dashboard 1500 and adding a pre-order for a system and method for dry cleaning and/or laundry logistics. At 1502, data points viewed include, but are not limited to, total revenue, orders to be picked, orders to be delivered, and/or unpaid orders. At 1504, a detailed itemization of the delivery status is displayed. The user accesses, through the user interface of the application, to view columns of data including, but not limited to, order number, customer details, payment status, and/or order status. At 1506, payment may be fulfilled by cash, credit card, check, and/or pay later. The list of orders have states being completed, pre-order, draft, unpaid, delivery failed, alteration, client pick-up, and/or delivery failed. When the state of the order is completed, an example of an action taken is no action is required. Under the action column, the information about the name of the payment method is displayed to a customer, through the user interface of the display. If the credit card used for payment is a credit card, then the credit card number and the transaction date will be displayed through the display of the user interface. The delivery status column will display the state of the delivery based on the on fleet response There are two states shown, ready for delivery and delivery completed. An action is possible by a user clicking on a view order icon. The user will be redirected to an order details page. A charge action icon may be selected by a user to charge a customer using a different payment method. In an example, if the make order icon is selected by a user, the user will be taken to an order intake module for an order selected.

When the payment alert box opens and is displayed to a user, a credit card dropdown menu for credit card payments is displayed. The payment alert box fields include, but are not limited to, select payment method, select the credit card listed in the system, amount, and/or notes. The actions possible on this alert box include, charge and complete when the customer is present, charge and start delivery when a delivery is to be done using on fleet, and/or charge and ready for pick-up when the customer has requested a later pick-up.

When the payment alert box is displayed on the user interface, the cash dropdown menu is displayed. The fields on the payment alert box are to select the payment method, the email address pre-filled for the customer, a mobile number, and/or the amount due. When the user selects the charge icon, the cash module is updated.

When the payment alert box opens, there is a pay later dropdown selection. The fields on the payment alert box include, but are not limited to, select payment method, email address pre-filled for the customer, mobile number, and/or add credit amount. When the user selects the add credit icon, the amount will be added for the user in the view section.

When the payment alert box opens, a check selection dropdown is displayed. The fields on the payment alert box include, but are not limited to, select payment method, check number, amount, upload images. When the user selects the add and/or save icon, the amount will be deducted offline when the check is deposited.

When the state of the order is pre-order, the action taken may include a charge action. A charge action icon may be selected by a user to charge a customer using a different payment method. In an example, if the make order icon is selected by a user, the user will be taken to an order intake module for an order selected. The delivery columns have not data in this state.

When the state of an order is a draft, the action that may be taken includes, selecting a view order icon by a user to be directed to an order details page. An action and a delivery column have no data in this state.

When the state of an order is unpaid, an action in the action column of the user interface includes a charge action button. If selected by a user, the customer will be charged using a different payment method. In this state, the delivery columns have no data. In an example of a possible action in this state, a user may select the view order icon to direct a user to be taken to an order details page for their order.

During the alteration state of an order, the actions column may have a contact tailor icon. This button may be configured to remind the user with an alert and/or a message to contact the tailor offline and/or to contact the tailor directly. Another state is tailor's job complete and pay the tailor. The tailor payment icon will be displayed to a customer with a payment alert message displayed to a customer on the user interface of the application. Another action that may be taken during the alteration state of an order is the selection of a view order icon. A user may be taken to an order details page for a specific order. In this state of order, the delivery column will have no data. The three states available for this column is request tailor pick-up, tailoring, and delivered to store. The data received from on fleet will allow the state to be updated.

When the state of the order is delivery failed, the action that may be taken includes, but is not limited to, an on fleet task and/or a contact client action. When a user selects the on fleet task icon, a request is sent to the on fleet and a task is created again for delivery. When a user selects the contact client icon, the user will be redirected to the client details module. This state of order will have no delivery data. The column has two states. The first message will be displayed to a user to show the three states with delivery failed state. The second message will be displayed to a user to illustrate the state of the new delivery. Data in these message boxes will be filled based on the on fleet responses. When the view order icon is selected by a user, the user will be directed to the order details page for their desired order.

When the state of the order is client pick-up, the action elements include client pick-up and contact client. During client pick-up, once the client has picked up the cleaned garment from the store, the user can select this icon to change the state of the order to complete. During contact client, this icon will redirect the user to the client details module. In this state the delivery column has no data. When the view order is selected by a user, a user will be directed to the order details page for the specific order.

When the state of the order is pay later, the action may include a user selecting the action element, invoice sent and paid. When the user clicks on this button, the state can be updated to completed and an invoice will be sent to the customer on the registered email address on file. In this state the delivery column has no data. This column has the state of ready for delivery and delivery completed. When the view order is selected by a user, a user will be directed to the order details page for the specific order.

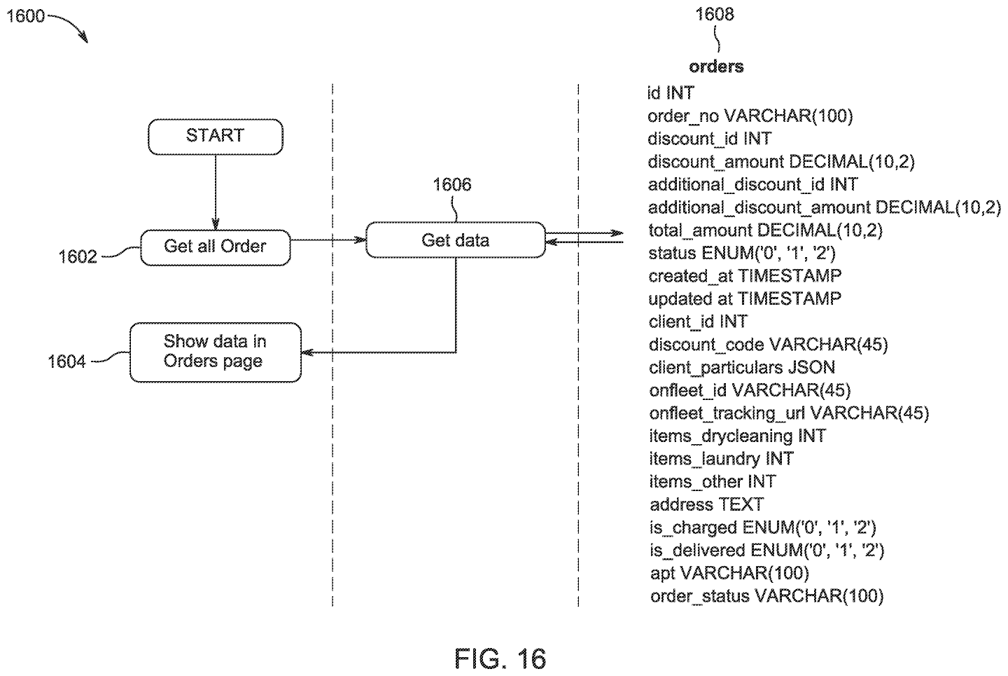

FIG. 16 depicts an illustration of a block diagram of embodiment 1600 of a module for stages of an order for a system and method for dry cleaning and/or laundry logistics of FIG. 15. At 1602, the order is retrieved. At 1606, the order data is obtained. At 1604, the data is displayed on the orders page. At 1608, the order is created and timestamped.

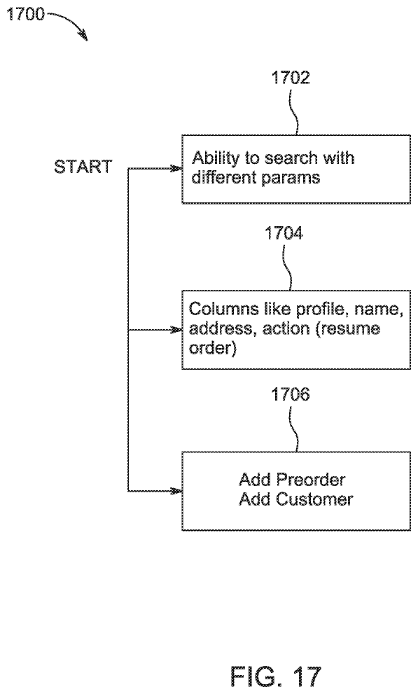

FIG. 17 depicts a flow chart illustrating a draft order dashboard 1700 for a system and method for dry cleaning and/or laundry logistics. At 1702, the user has an ability to search with different parameters. At 1704, columns shown have a list of data for profile, name, and/or address information associated with a draft order. Pagination may be added. Filter functionality is a feature of this embodiment. It is within the scope of this invention for a user to click on resume order and go back to the order details module and complete the order. Further, a user may navigate back to the customers list and/or the orders list. At 1706, a preorder and/or a customer may be added.

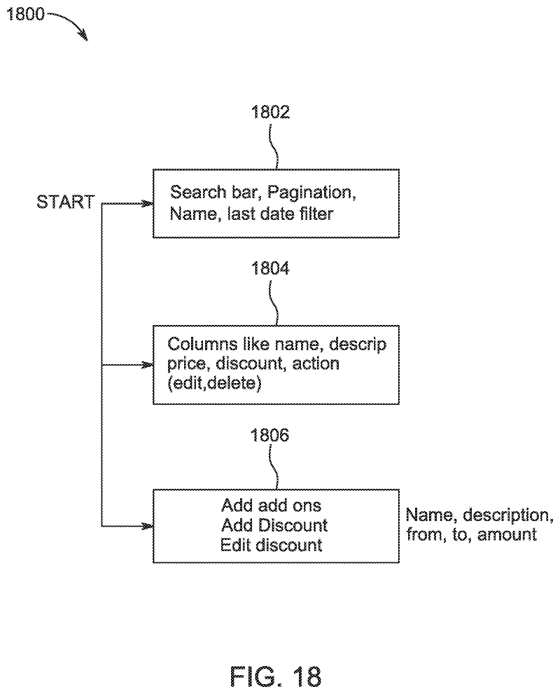

FIG. 18 depicts a flow chart illustrating discounts dashboard 1800 for a system and method for dry cleaning and/or laundry logistics. At 1802, the search bar, pagination, name, and last date filter are some examples of columns shown. At 1804, columns include, name, description of price, discount, and/or action such as edit and/or delete. At 1806, in the master module, users may define all discounts add an add-on, and/or add a discount. When showing the list of add-ons, a user may navigate to the customers list and/or the orders list. The add-ons may be added and/or edited. The fields shown include, but are not limited to, name, description, from date, to date, and/or amount of cost or percentage. A user may add a new add-on and/or edit the add-on.

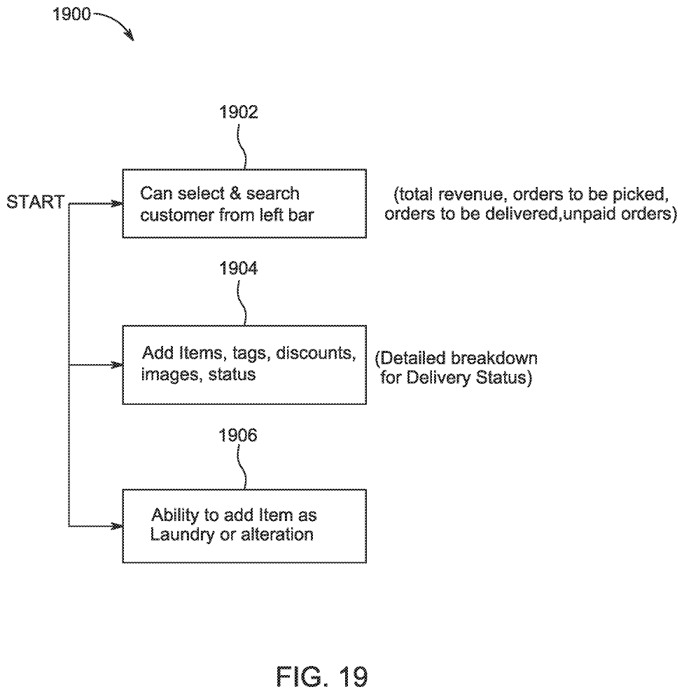

FIG. 19 depicts a flow chart illustrating adding orders in order intake dashboard 1900 for a system and method for dry cleaning and/or laundry logistics. At 1902, the selection and search options for a customer occur in the left bar such as the total revenue, orders to be picked-up, orders to be delivered, and/or unpaid orders. At 1904, items, tags, discounts, images, and status may be added. At 1906, an item may be added such as laundry and/or an alteration item.

When the user desires to add an order into the system, the order intake process begins with adding an item. When the user selects the add item icon, a pop-up is displayed. The user selects a price, quantity, discount amount or percentage, and/or a discount. A user may add add-ons to an item selected. For example, the color and the property of the add-on for blue, price, and/or discount price for each add-on.

A user may view the list of items added in the receipt displayed on at least a portion of the display. When adding a tag, an order identification field generates an identifier displayed on the display. The tag identifier may be manually entered or automatically displayed. The tag identifier is associated with a dropdown menu that a user may select an item. The dropdown menu may be prefilled with the items added in the cart by a user. The user may add tags. Discounts may be added in a list displayed to a user. It is within the scope of this invention for a user to add images of dirty clothes and add notes.

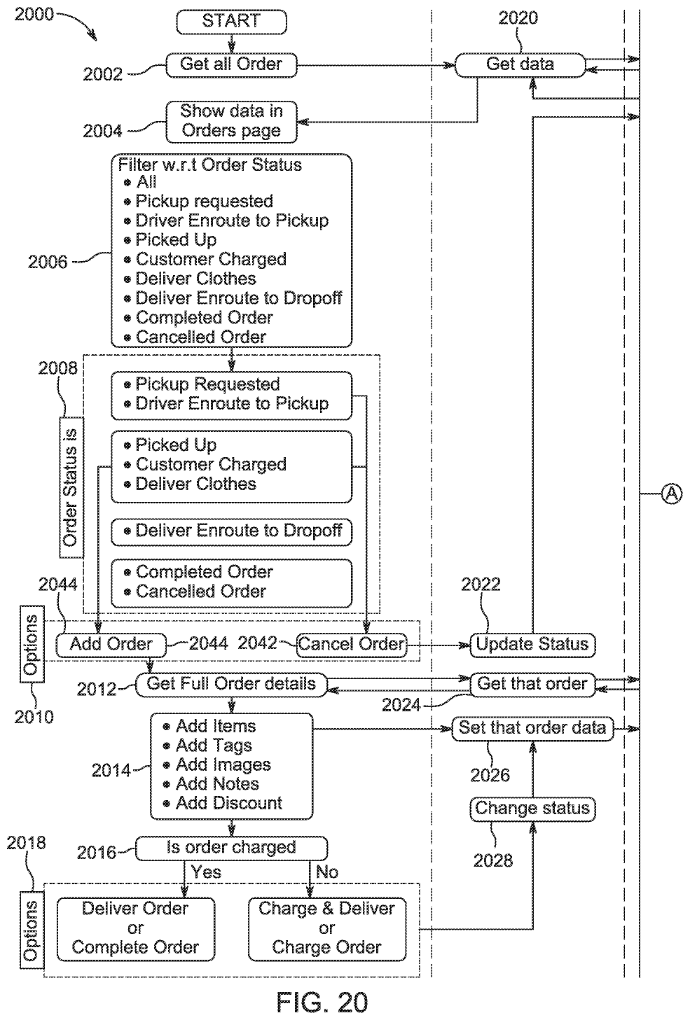

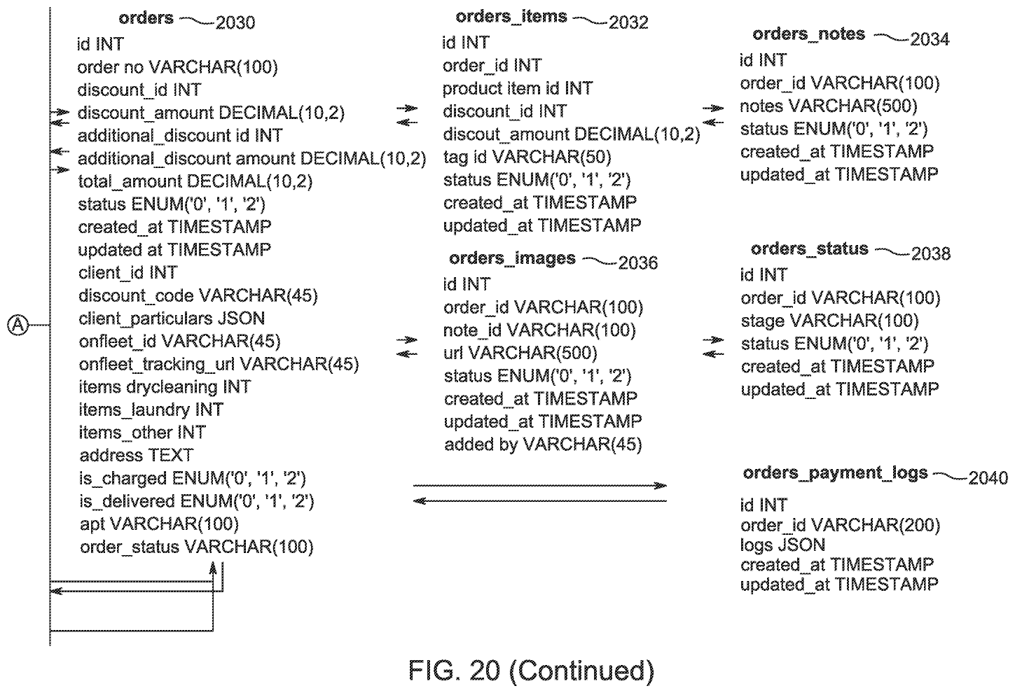

FIG. 20 depicts an illustration of a block diagram of an embodiment of adding orders in order intake dashboard 2000 for a system and method for dry cleaning and/or laundry logistics of FIG. 19. At 2002, the order is retrieved. At 2020, the data is received. At 2004, the data is displayed in the orders page. At 2006, the order status is filtered by all, pick-up requested, driver enroute to pick-up, customer charged, deliver clothes, driver enroute to drop-off, completed order, and/or canceled order. At 2008, if the order statis is a pick-up requested and/or driver is enroute to pick-up, the order may be canceled at 2042 and the status is updated at 2022. If the order status is picked up, customer charged, and/or deliver clothes at 2044, an order may be added. At 2012, full order details are generated and displayed. At 2023, the order is retrieved. At 2014, added items, tags, images, notes, and/or discounts may be added. At 2026, order data is set. At 2016, if order is charged, then at 2018 the order may be delivered and/or the order may be completed. At 2016, if order is not charged, then at 2018 the order may be charged and delivered and/or the order may be charged. At 2010, options are to add order 2044 and/or cancel order 2042. At 2028, the order status may be updated. At 2030, the order is created and updated with a timestamp. At 2032, order items are created and updated with a timestamp. At 2034, order notes are created and updated with a timestamp. At 2036, order images are created and updated with a timestamp. At 2038, order status is created and updated with a timestamp. Users may visualize on the display the state of the order. States with date timestamps include, but are not limited to, pick-up requested, driver assigned, picked up delivered to store, order intake, customer charged, deliver clothes, and/or order complete. At 2040, order payment logs are created and updated with a timestamp. At 2024, the order is retrieved.

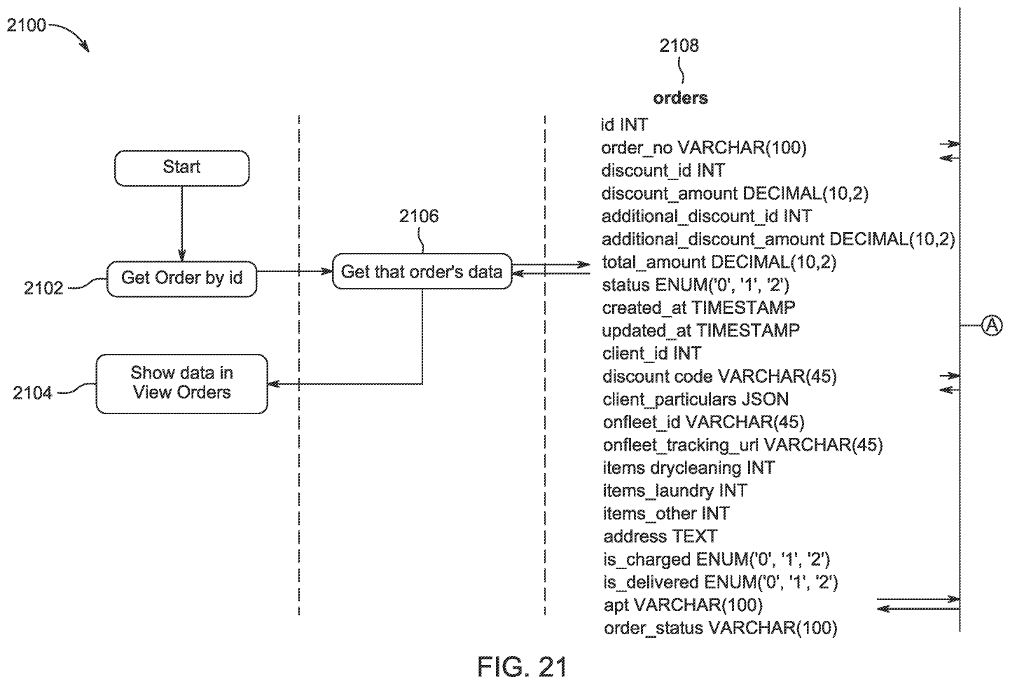

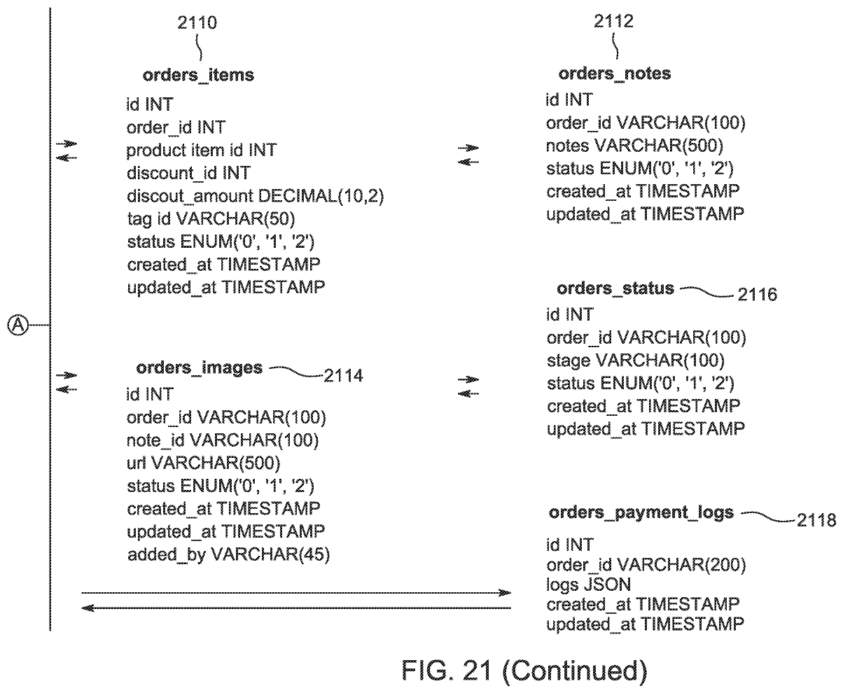

FIG. 21 depicts an illustration of a block diagram of an embodiment of order details module 2100 for a system and method for dry cleaning and/or laundry logistics. At 2102, the order is generated by an associated identifier. At 2106 the data of an order is retrieved. At 2104, the data is displayed in view orders. At 2108, the orders data is created and updated with a timestamp. At 2110, order items are created and updated with a timestamp. At 2112, the orders notes are created and updated with a timestamp. At 2114, the orders images are created and updated with a timestamp. At 2116, the orders status is created and updated with a timestamp. At 2118, the orders payment logs are created and updated with a timestamp. When a user selects on view order from the orders page, a user will be redirected to the order details page. The fields on the order details page include, but are not limited to, receipt with the items, subtotal, price, tags associated with assigned items and a list of tags, states with date timestamps, and/or image notes.

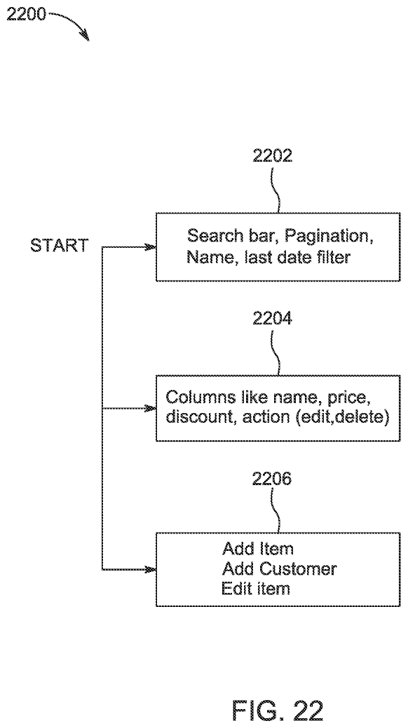

FIG. 22 depicts a flow chart illustrating items master module 2200 for a system and method for dry cleaning and/or laundry logistics. At 2202, search bar, pagination, name, and last date filter are shown. At 2204, a list of items such as name, price, discount are shown. At 2206, a user may edit, add, and/or delete an item. A customer may be added.

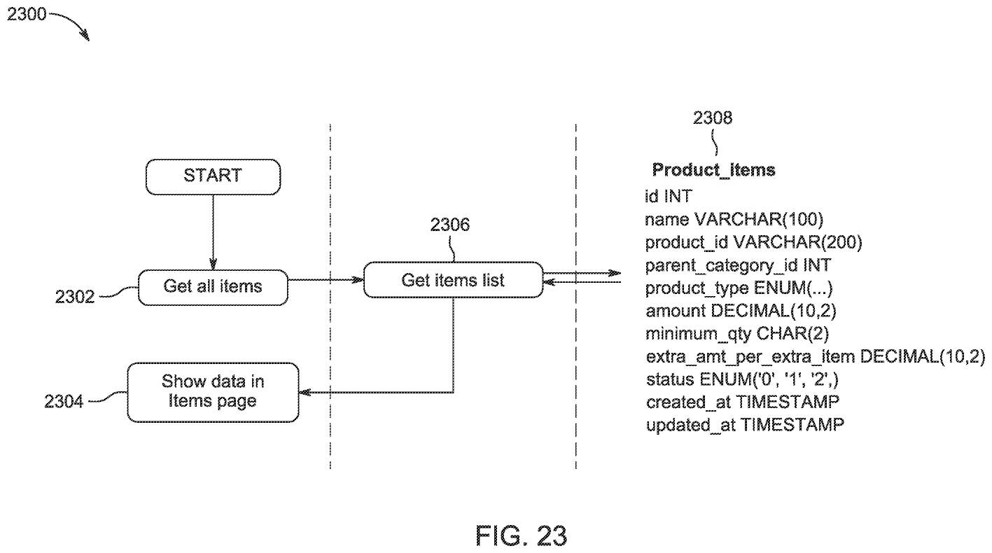

FIG. 23 depicts an illustration of a block diagram of an embodiment of items module 2300 for a system and method for dry cleaning and/or laundry logistics of FIG. 22. At 2302, all items are retrieved. At 2306, the item list is retrieved. At 2304, the data is displayed in the items page. At 2308, product items are created and updated with a timestamp.

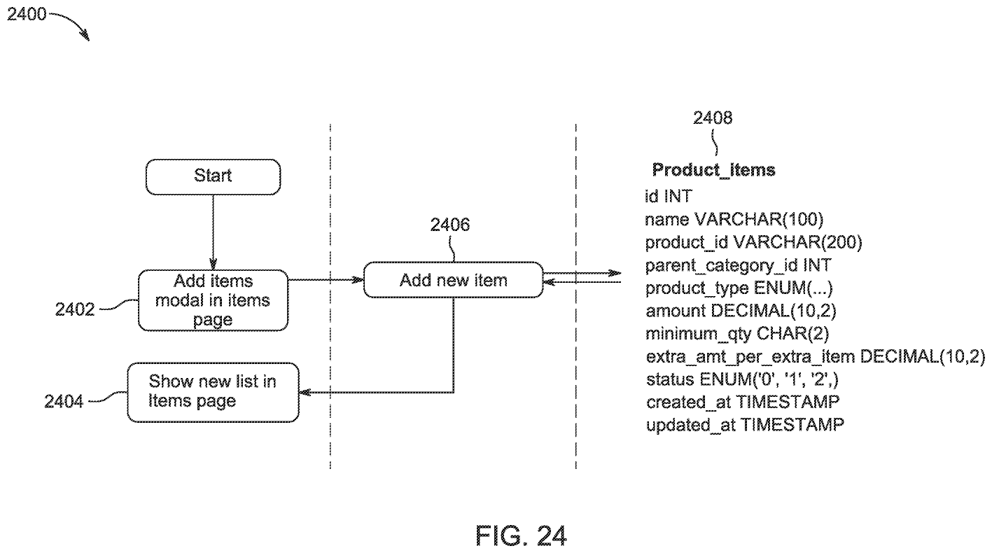

FIG. 24 depicts an illustration of a block diagram of an embodiment of items module 2400 having the ability to add an item for a system and method for dry cleaning and/or laundry logistics. At 2402, items are added in the items page. At 2406, a new item is added. At 2404, the new list is displayed in the items page. The fields shown are name, price, and/or discount. At 2408, the product items are created and updated with a timestamp.

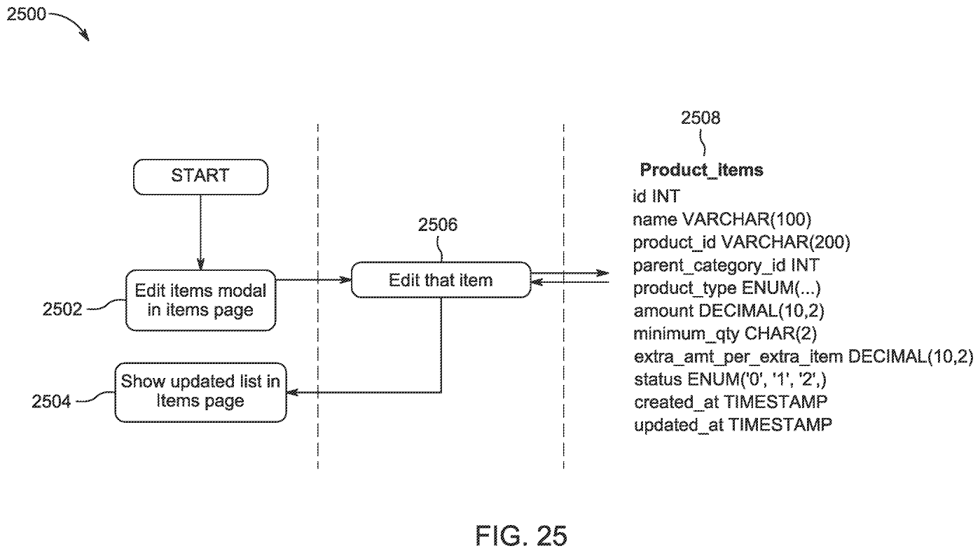

FIG. 25 depicts an illustration of a block diagram of an embodiment of items module 2500 having the ability to edit an item for a system and method for dry cleaning and/or laundry logistics. At 2502, items may be edited in the items page. At 2506, an item is edited. At 2504, the updated list is displayed in the items page. At 2508, product items are created and updated with a timestamp.

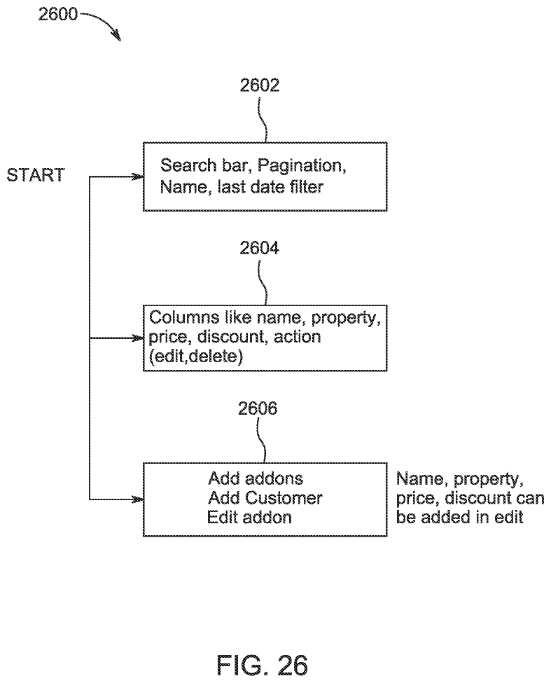

FIG. 26 depicts a flow chart illustrating add-ons master module 2600 for a system and method for dry cleaning and/or laundry logistics. At 2602, the search bar, pagination may be added, filter functionality is available, name, and/or last date may have a column listed. At 2604, columns listed include, name, property price, discount and/or an action. At 2606, a user may define the add-on data. The user may edit the item, delete the item, navigate to a customer's list, add a customer, and/or navigate to an orders list.

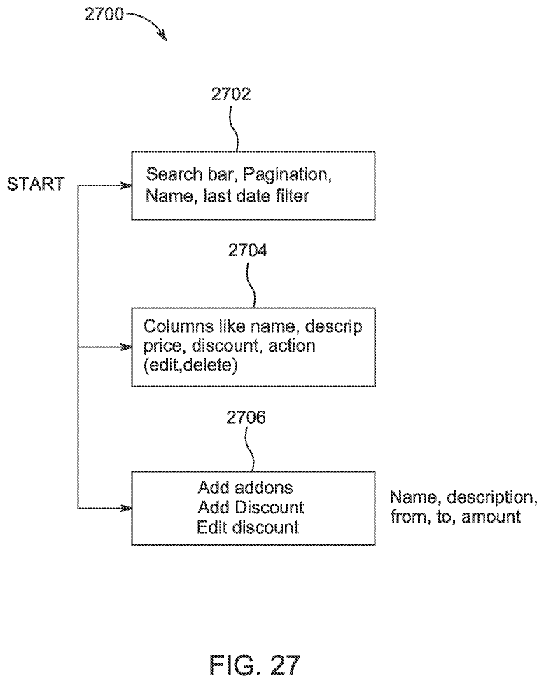

FIG. 27 depicts a flow chart illustrating discounts dashboard 2700 for a system and method for dry cleaning and/or laundry logistics in which a user may define all the discounts. At 2702, the search bar, pagination may be added, filter functionality is available, name, and/or last date may have a column listed. At 2704, columns shown include, but are not limited to name, description, amount, discount, action, and date of availability. At 2706, a user may define the discount data. The user may edit the item, delete the item, navigate to a customer's list, add a customer, and/or navigate to an orders list.

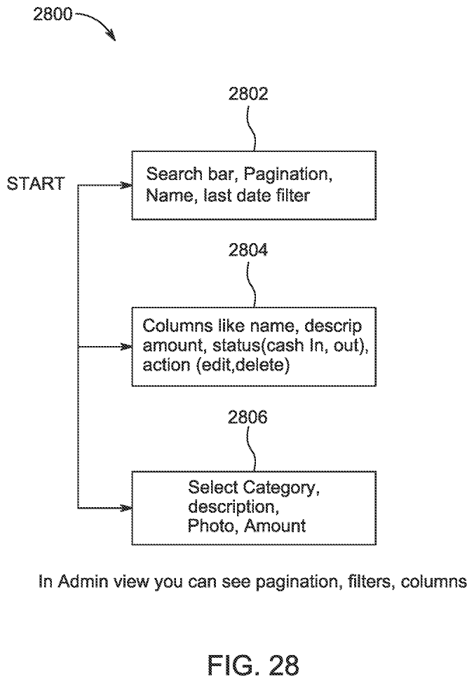

FIG. 28 depicts a flow chart illustrating cash flow module 2800 for a system and method for dry cleaning and/or laundry logistics. This module maintains cash flow throughout the day. In an example, each employee adds cash in and cash out entries when cash is added and/or removed from the store. Cash left and calculated cash left amount at the end of a day should be equal. If not, then a notification will be sent to the administrator regarding the discrepancy. At 2802, the search bar, pagination may be added, filter functionality is available, name, and/or last date may have a column listed. At 2804, columns shown include, but are not limited to name, description, status of cash in, status of cash out, and/or action. At 2806, selecting category, description, photo and/or amount may be available to a user.

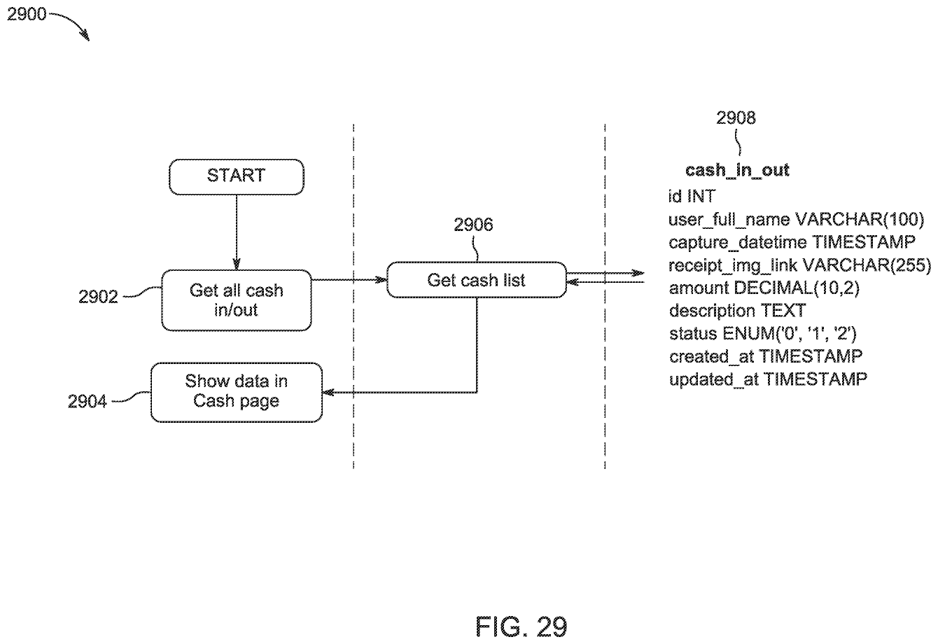

FIG. 29 depicts a flow chart illustrating an embodiment of for cash flow module 2900 for a system and method for dry cleaning and/or laundry logistics. At 2902, all cash in and all cash out is received. At 2906, a cash list is generated. At 2904, data is displayed in the cash page. At 2908, cash in and/or out is created and updated with a timestamp.

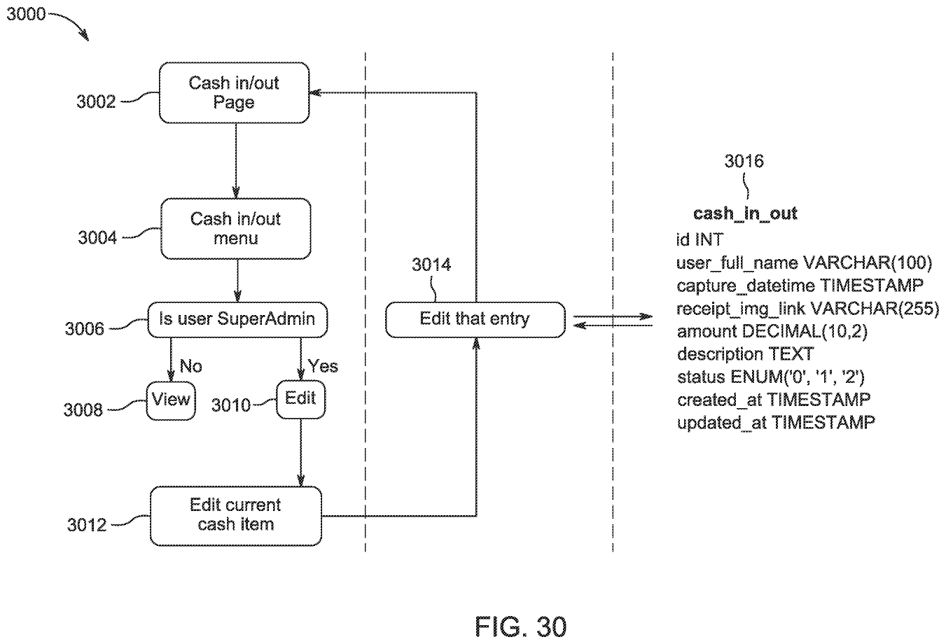

FIG. 30 depicts a flow chart illustrating cash register module 3000 configured to edit a cash entry for a system and method for dry cleaning and/or laundry logistics. In this embodiment, the ability for a user to add and edit a cash entry is shown. At 3002, a cash in/out page is displayed. At 3004, a cash in/out menu is generated and displayed. At 3006, if the administrator is an authorized user, at 3010, they may be determined by the system to have authorization to edit data. If the administrator is not an authorized user, at 3008, they may be determined by the system to have not be authorization to edit data and to only view data. At 3012, the authorized administrator may edit a current cash item. At 3014, an entry is edited. At 3016, cash in and/or out is created and updated with a timestamp.

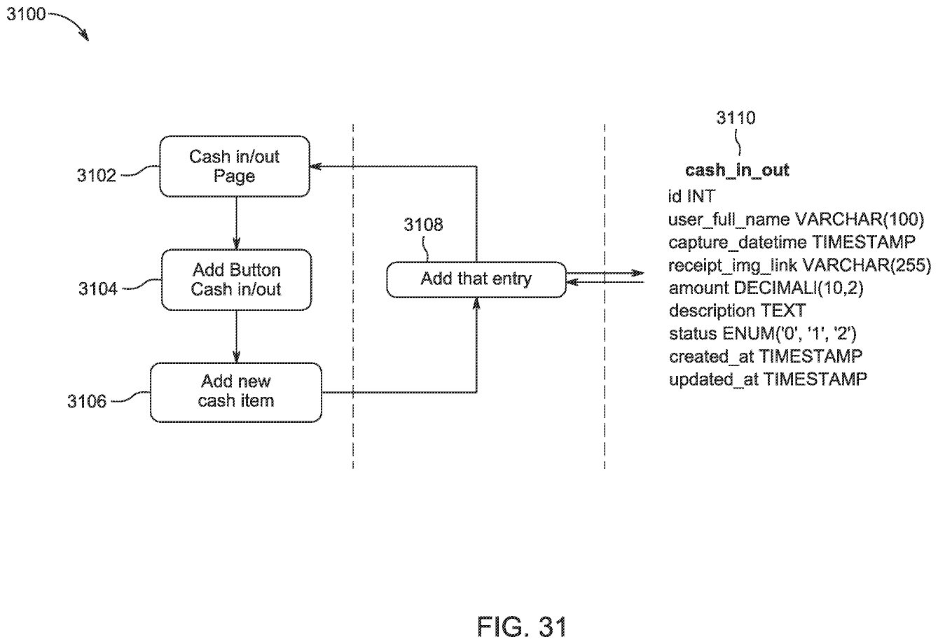

FIG. 31 depicts a flow chart illustrating an embodiment of cash register module 3100 configured to add a cash entry for a system and method for dry cleaning and/or laundry logistics. At 3102, the cash in/out page shows a list of cash flow entries. The list will display only cash in and cash out entries done by all the users. There are four cards shown on the main screen with data points including, but not limited to, total revenue, starting cash, current cash, ending cash, and/or a date and day. At 3104, add button is selected for cash in/out. At 3106, a new cash item is added. At 3108, an entry is added. At 3110, cash in and/or out is created and updated with a timestamp.

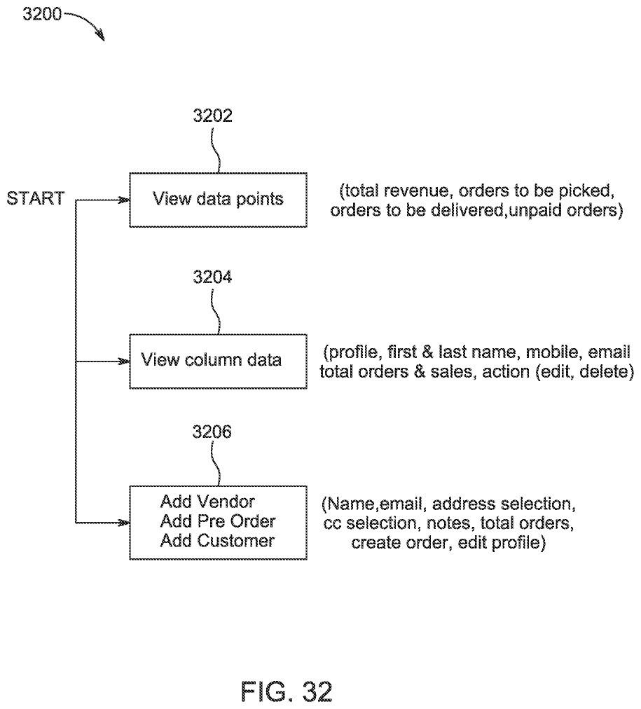

FIG. 32 depicts a flow chart illustrating a module showing vendor listing 3200 for a system and method for dry cleaning and/or laundry logistics. This module shows the list of all vendors associated with an alteration service, for example. At 3202, the data point listed are displayed such as total revenue from alteration, alteration orders in progress, alteration orders completed, and/or total amount paid to the tailors. At 3204, the column data is shown including, but not limited to, profile data, first name, last name, mobile, email address, total orders, total sales, and/or last order. At 3206, details of a vendor, a pre=order, and/or a customer may be added.

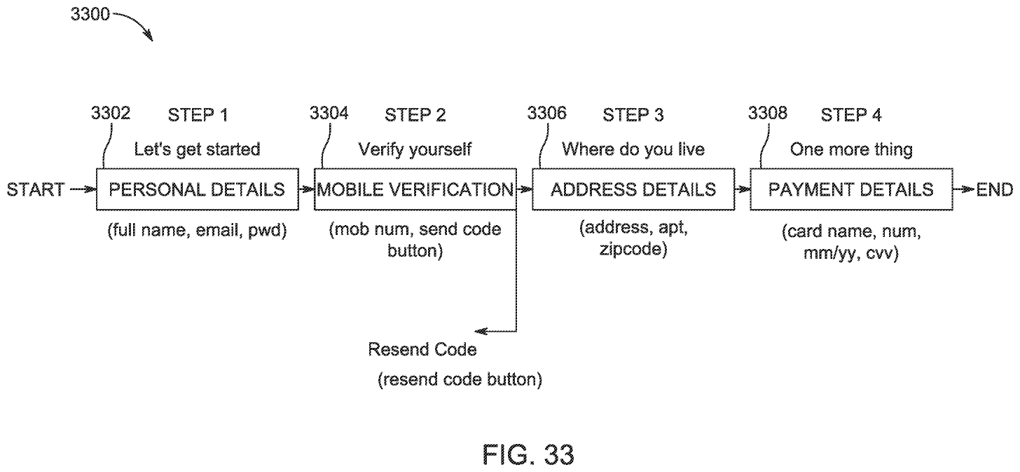

FIG. 33 depicts a flow chart illustrating third party sign-up module 3300 for a system and method for dry cleaning and/or laundry logistics. At 3302, adding personal details includes, but is not limited to, full name, email address, and/or a password. At 3304, mobile verification occurs and the data collected is a mobile number and a resend code button is provided. At 3306, address details are collected including, but not limited to, address, apartment number, and/or zip code. At 3308, payment details are collected including, but not limited to, card name, card number, expiration data, and/or security code.

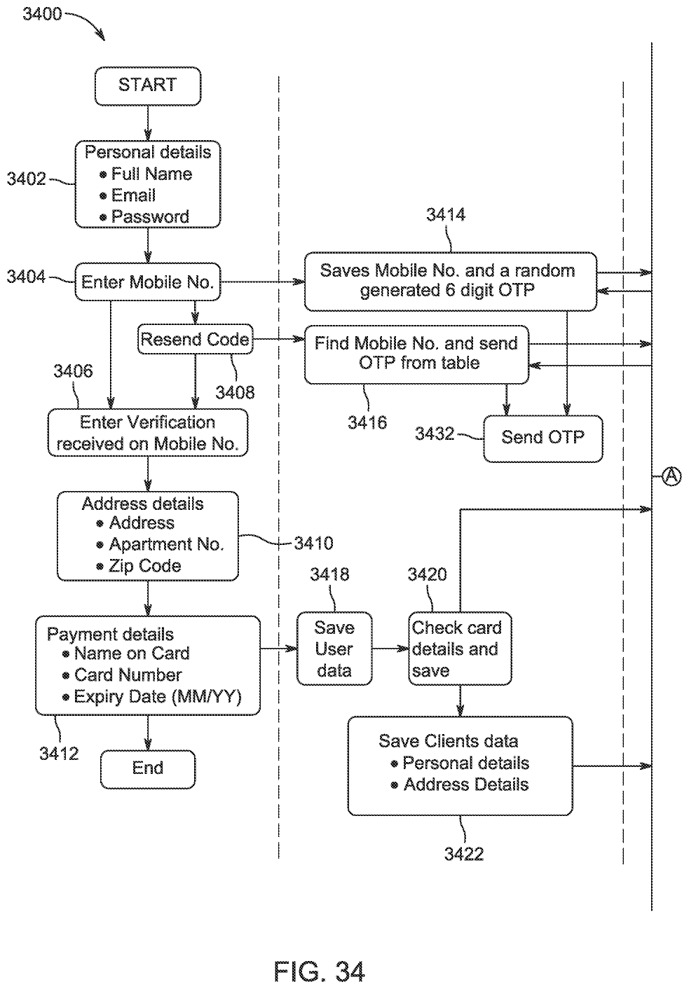

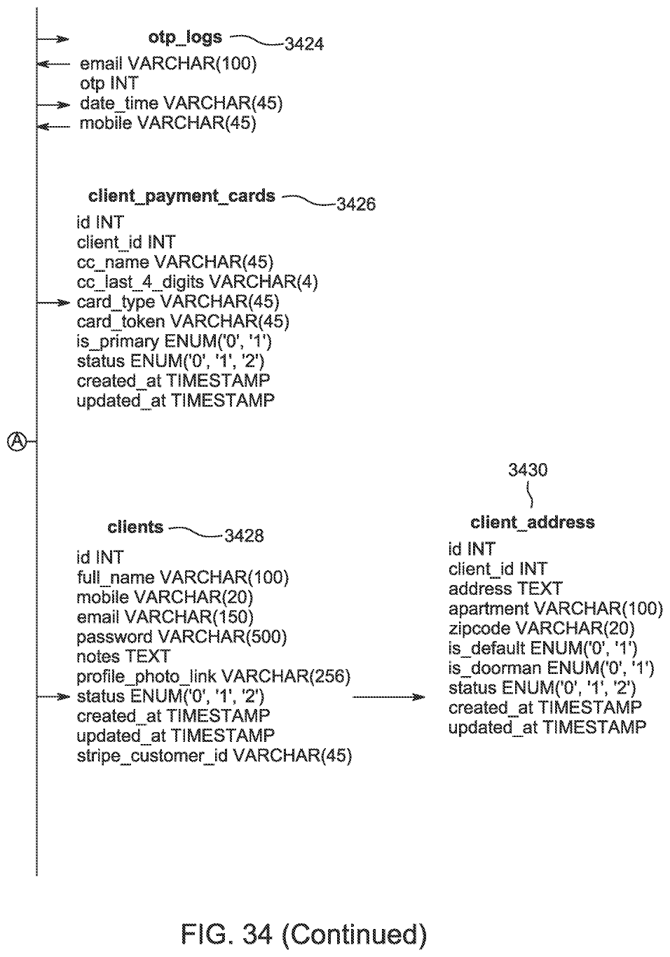

FIG. 34 depicts an illustration of a block diagram of an embodiment for third party sign-up module 3400 for a system and method for dry cleaning and/or laundry logistics of FIG. 33. At 3402, personal details such as full name, email, and password are collected. At 3404, entering a mobile number is performed by a user. At 3414, the mobile number is saved and a random six digit identifier such as a one-time password (OTP) is generated. At 3424, OTP logs are available. At 3408, the code is resent. At 3416, the mobile number is found and an OTP is sent from the table. At 3432, an OTP is sent. At 3406, a verification code sent to the mobile number is entered by a user. At 3406, the verification number is received by an electronic device associated with a mobile number. The verification number is entered. At 3410, Address details are collected. At 3412, payment details are collected. At 3418, user data is saved. At 3420, card payment details are checked for accuracy and saved. At 3422, client data is saved such as, personal details and address details. At 3426, client payment card data creates and updates a timestamp. At 3428, client data creates and updates a timestamp. At 3430, client address data creates and updates a timestamp.

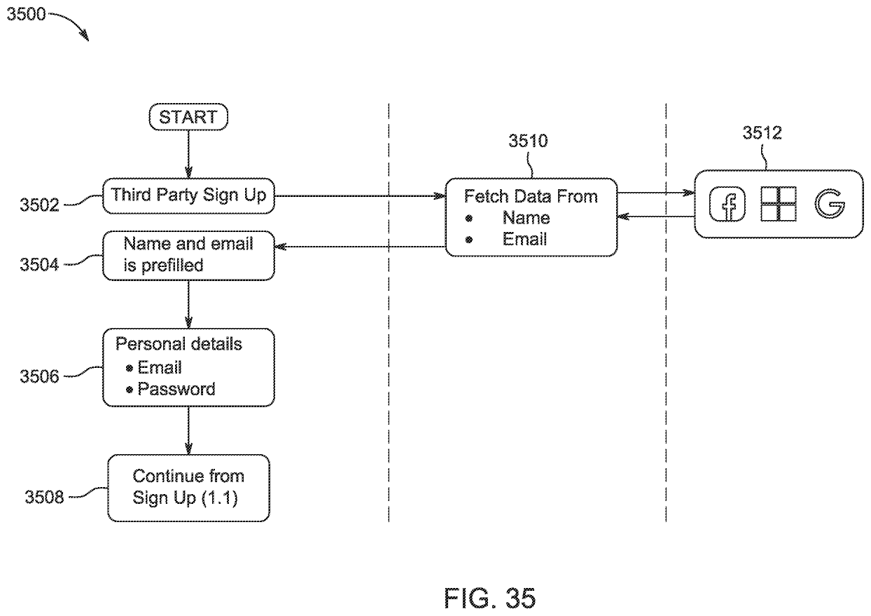

FIG. 35 depicts an illustration of a block diagram of an embodiment for third party sign-up module 3500 for a system and method for dry cleaning and/or laundry logistics. At 3502, a third party sigh up page is displayed. At 3510, data such as name and email is retrieved. At 3504, name and email is prefilled in the webform field. At 3506, personal details such as email and password are input by a user into the webform. At 3508, continuing from sign-up occurs. At 3512, a third party includes, but is not limited to, Facebook, email, and/or Microsoft.

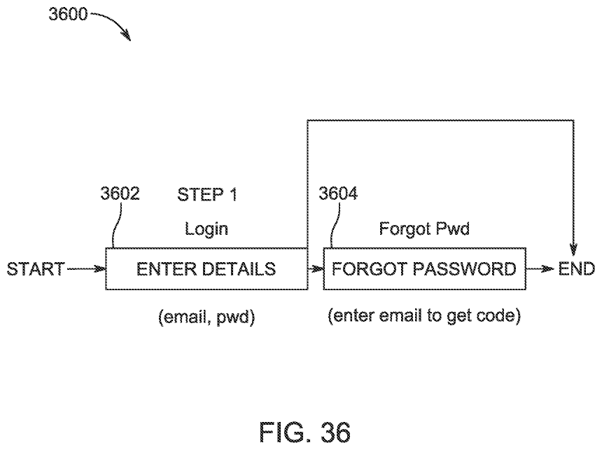

FIG. 36 depicts a flow chart illustrating third party login module 3600 for a system and method for dry cleaning and/or laundry logistics. At 3602, login details are entered such as email address and/or a password. At step, 3604, if the password is forgotten, the email address may be input to output a new code. The new code is sent to the email address in file. A new password may be reset and confirmed.

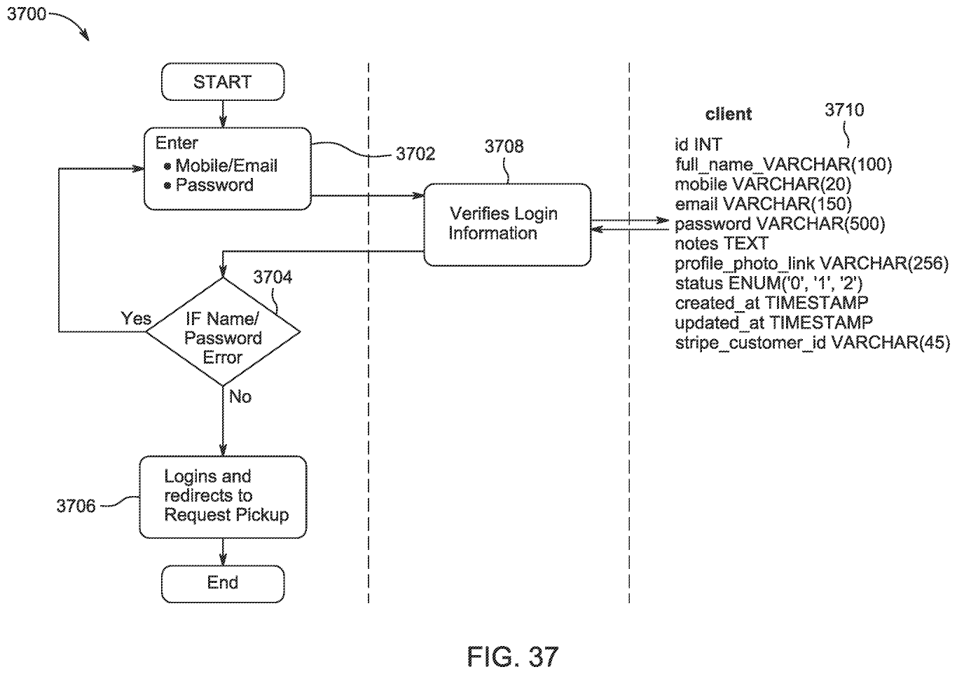

FIG. 37 depicts an illustration of a block diagram of an embodiment for third party sign-login module 3700 for a system and method for dry cleaning and/or laundry logistics of FIG. 36. At 3702, a mobile number and/or password is entered into the interface. At 3708, login information is verified. At 3710, client data is created and updated with a timestamp. At 3704, if the name and/or password is in error, the user is prompted to enter the mobile number and/or password again. If the name and/or password is not in error, at 3706, logins and redirects client to request pick-up.

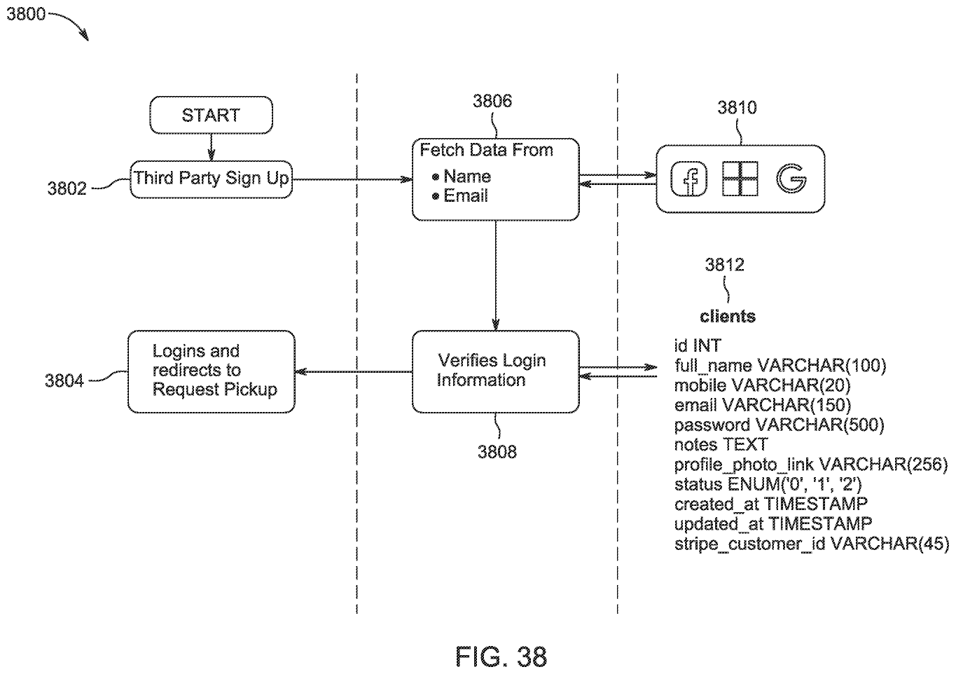

FIG. 38 depicts an illustration of a block diagram of forget password module 3800 for a system and method for dry cleaning and/or laundry logistics. At 3802, a user signs up using a third party. At 3806, data id retrieved from a name and email provided by a user. At 3808, login credentials are verified. At 3804, logins and redirects to request pick-up. At 3810, a user may sign in using a third party including, but not limited to, Facebook, Gmail, and/or Microsoft login credentials. At 3812, client data is created and updated with a timestamp.

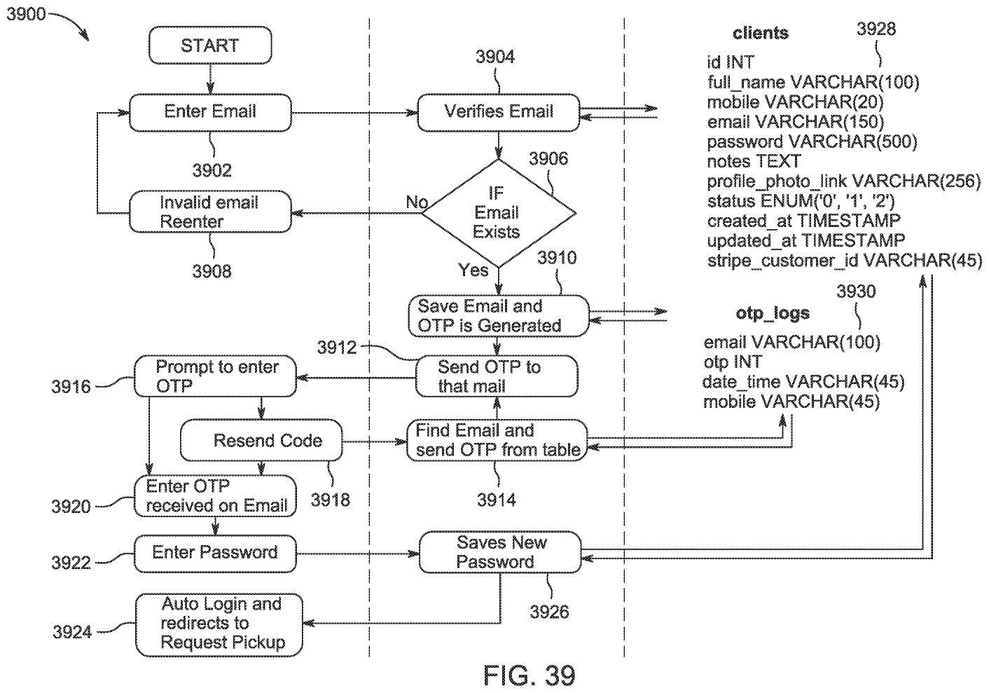

FIG. 39 depicts an illustration of a block diagram of an embodiment for forget password module 3900 for a system and method for dry cleaning and/or laundry logistics. At 3902, an email address is entered. At 3904, the email address is verified. At 3928, client data is created and updated with a timestamp. At 3906, the system determines if an email address exists. At 3908, if the email does not exist, the email address is invalid and a user is prompted to reenter the email address. At 3910, if the email address exists, the email address is saved and an OTP is generated. At 3930, OTP logs are available. At 3912, an OTP password is sent to the associated email address. At 3916, a user is prompted to enter the OTP. At 3918, the OTP code is resent. At 3914, the email address is found and the OTP is sent from the table. At 3920, the OTP received by the email address is entered into the system. At 3922, a password is entered by a user. At 3924, auto login occurs and redirects a user to request a pick-up. At 3926, the new password is saved.

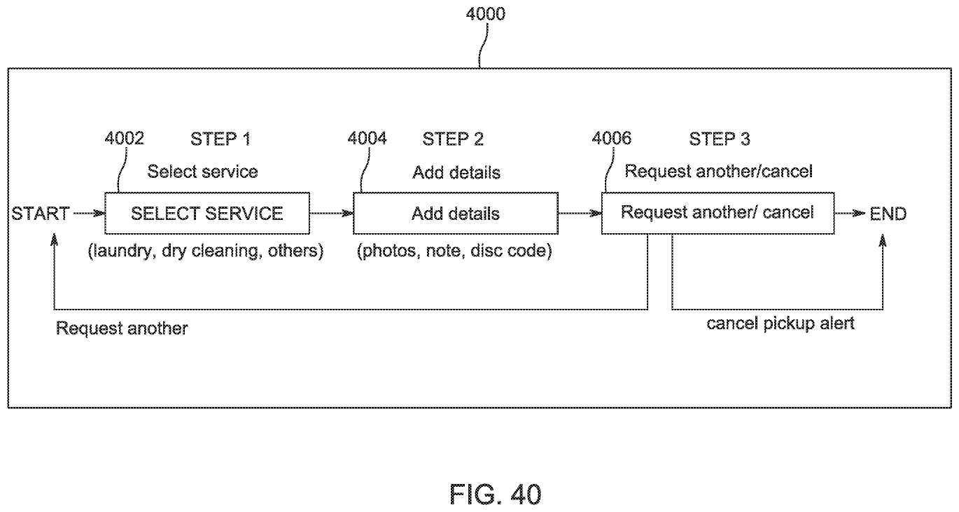

FIG. 40 depicts a flow chart illustrating request pickup module 4000 for a system and method for dry cleaning and/or laundry logistics. At 4002, a service is selected from the options including, but not limited to, laundry, dry cleaning, shoes, alterations, leather, and/or suede. An address from where a pick-up location is submitted through the webform. At 4004, details are added including, but not limited to, photos, a note, and/or a discount code. At 4006, a subsequent pick-up may be requested. Alternatively, an alert may be generated to confirm is a pick-up has been canceled.

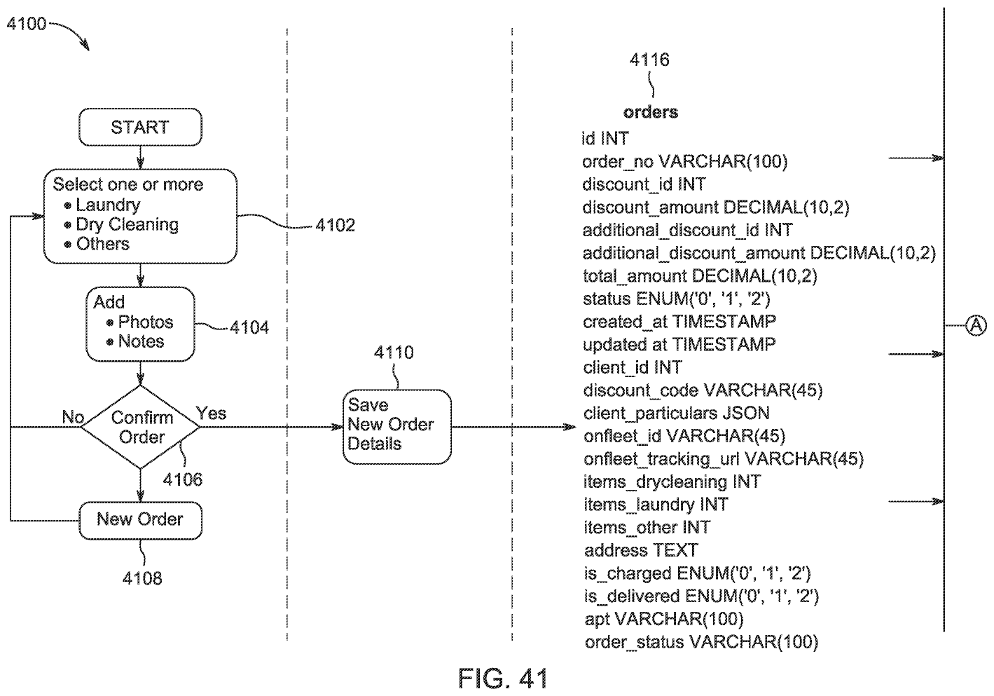

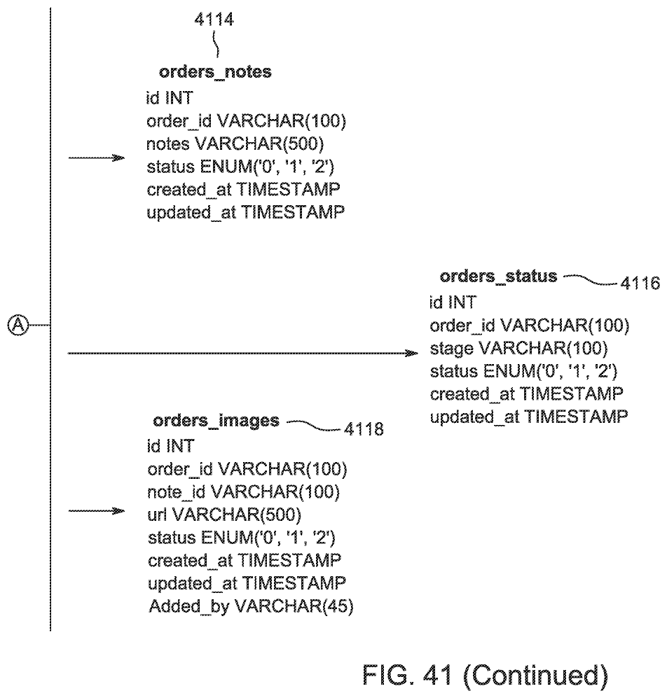

FIG. 41 depicts an illustration of a block diagram of an embodiment for request pickup module 4100 for a system and method for dry cleaning and/or laundry logistics. At 4102, a service is selected from the options including, but not limited to, laundry, dry cleaning, shoes, alterations, leather, and/or suede. At 4102, details are added including, but not limited to, photos, a note, and/or a discount code. At 4104, photos and/or notes may be added. At 4106, the order is confirmed. At 4110, new order details are saved. At 4108, a new order is generated. At 4112, order details are created and generated with a timestamp. At 4114, order notes are created and generated with a timestamp. At 4116, order status details are created and generated with a timestamp. At 4118, order image details are created and generated with a timestamp.

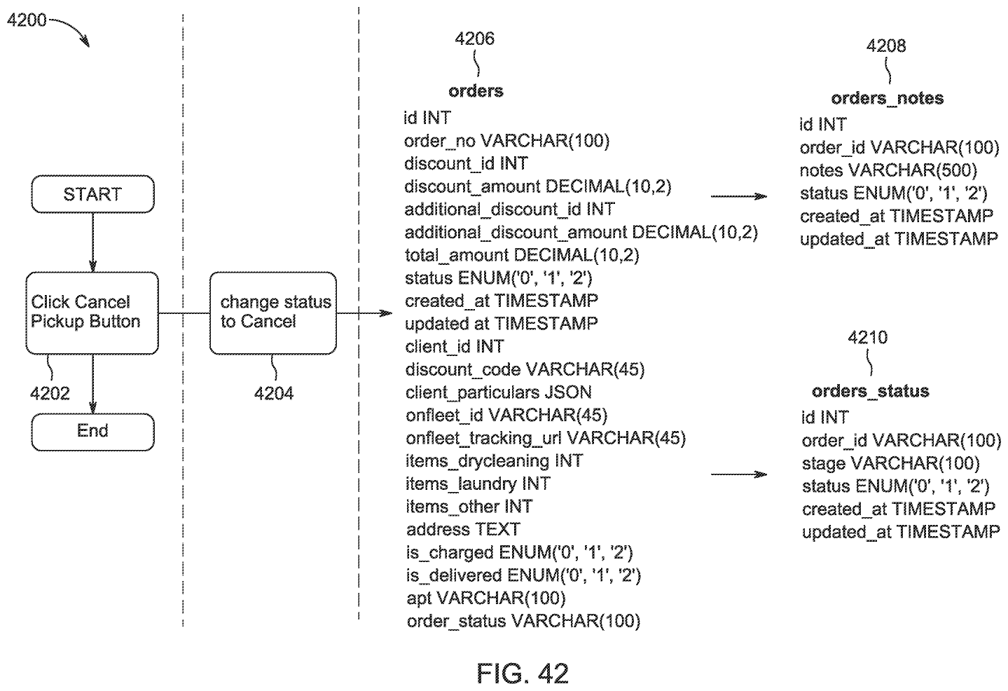

FIG. 42 depicts an illustration of a block diagram of an embodiment for cancel pickup module 4200 for a system and method for dry cleaning and/or laundry logistics. Canceling an order after a predetermined time may result in a cost incurred as a penalty and/or a violation. At 4202, a user may select a cancel pick-up icon in the user interface of the display having the application. At 4204, the status is changed to cancel. At 4206, order details are created and generated with a timestamp. At 4208, order note details are created and generated with a timestamp. At 4210, order status details are created and generated with a timestamp.

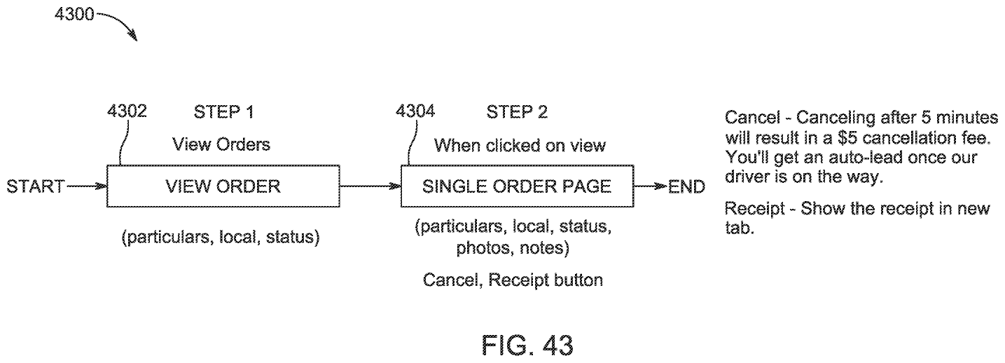

FIG. 43 depicts a flow chart illustrating a view orders module 4300 for a system and method for dry cleaning and/or laundry logistics. At 4302, the list of orders is viewable including, but not limited to, order details, photos, notes, total amount, status, and/or receipt data. At 4302, the order is viewable. At 4304, when the view button is selected, the total amount, status, a photo, a note, a detail of the order, and/or a cancellation button is available for a user to select.

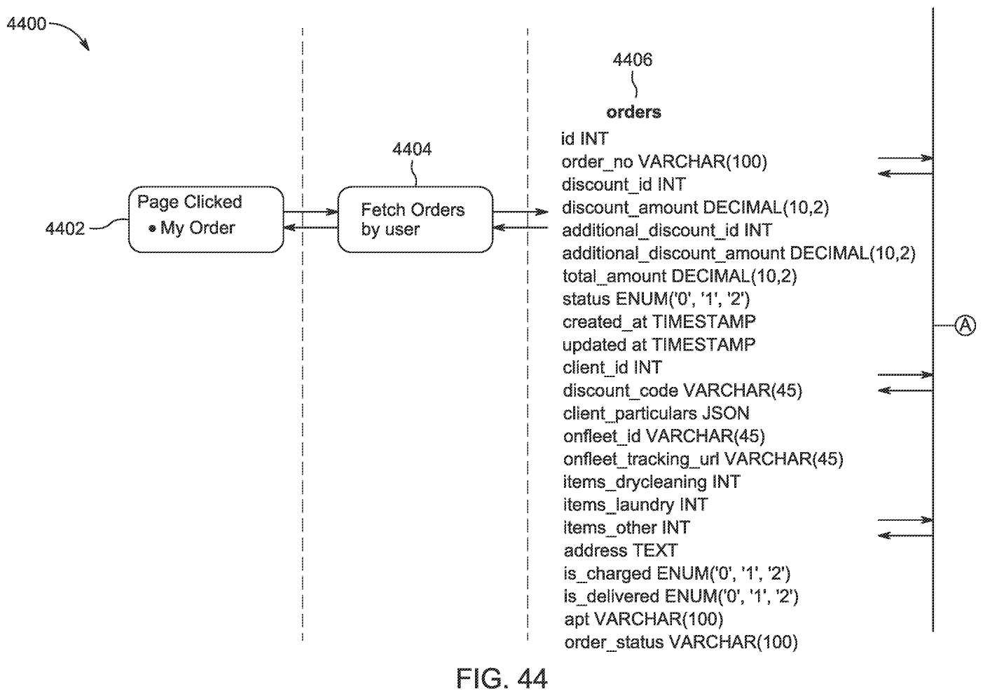

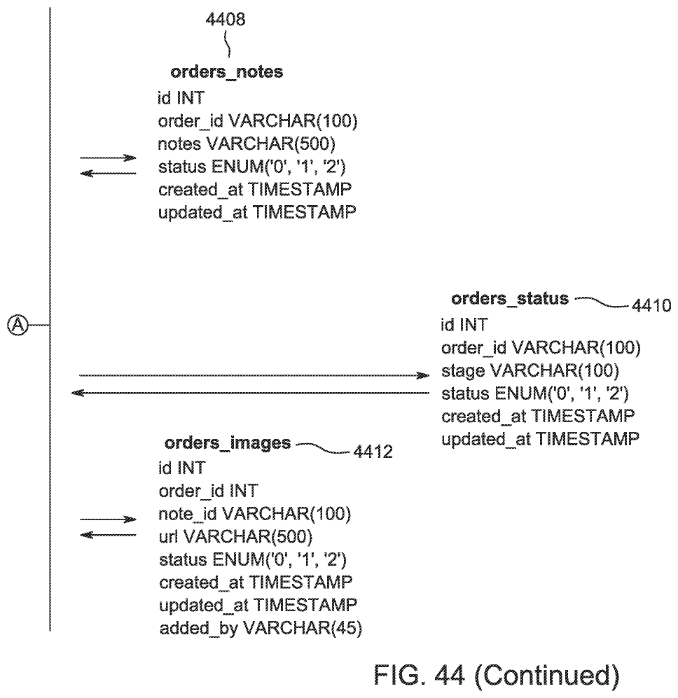

FIG. 44 depicts an illustration of a block diagram of an embodiment for view orders module 4400 for a system and method for dry cleaning and/or laundry logistics of FIG. 43. At 4402, when my order page is selected, a user clicks on the icon within the user interface of a display. At 4404, the user navigates to collect order data. At 4406, order details are created and generated with a timestamp. At 4408, order note details are created and generated with a timestamp. At 4410, order status details are created and generated with a timestamp. At 4412, order image details are created and generated with a timestamp.

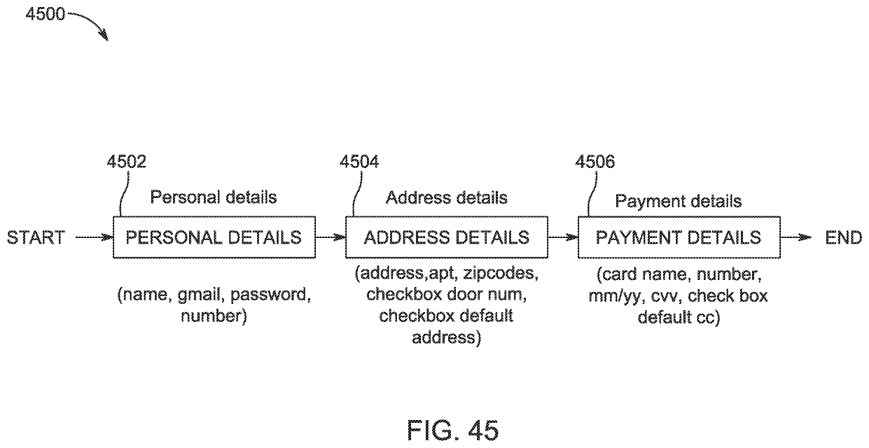

FIG. 45 depicts a flow chart illustrating profile module 4500 for a system and method for dry cleaning and/or laundry logistics. At 4502, personal details such as name, email address, password, mobile number, and/or profile photo are added to a profile. At 4504, a user inputs into the webform, address information, apartment information, and/or zip code. At 4506, payment details are input by a user into webform.

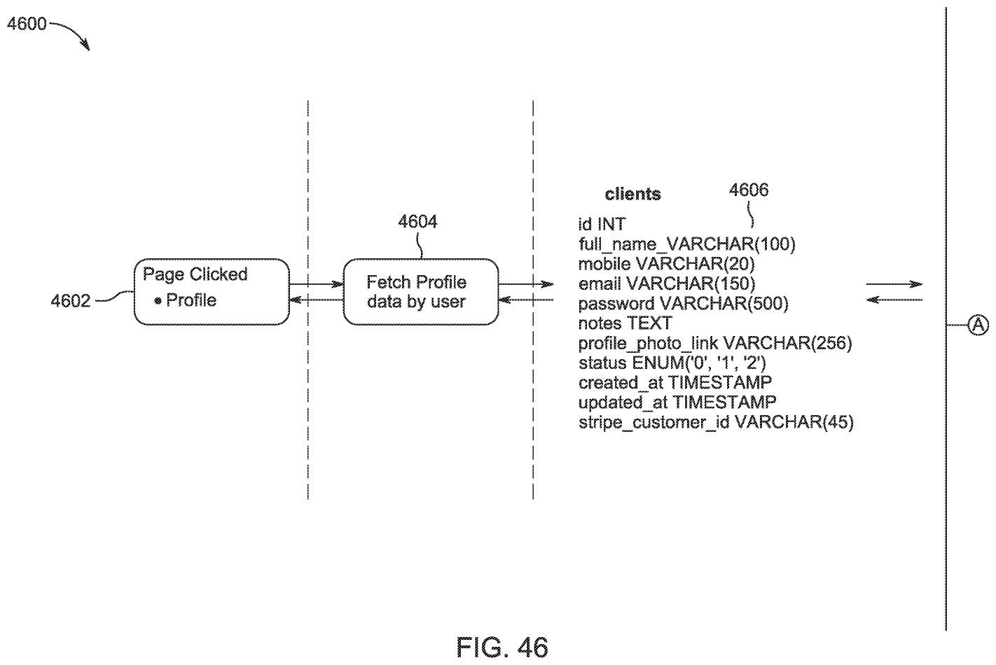

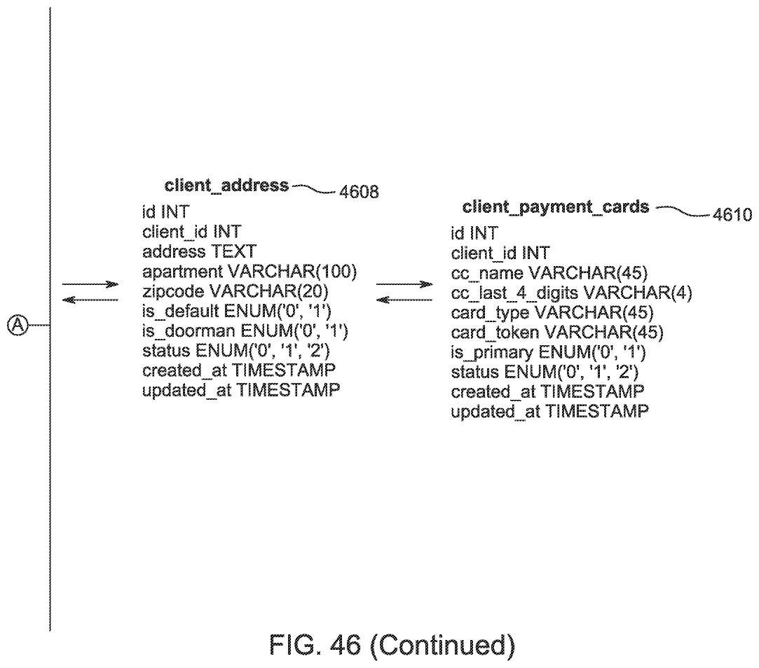

FIG. 46 depicts an illustration of a block diagram of an embodiment for profile module 4600 for a system and method for dry cleaning and/or laundry logistics of FIG. 45. At 4602, the profile page is selected by a user when a user clicks on the page. At 4604, the user retrieves the profile data. At 4606, client details are created and generated with a timestamp. At 4608, client address details are created and generated with a timestamp. At 4610, client payment card details are created and generated with a timestamp.

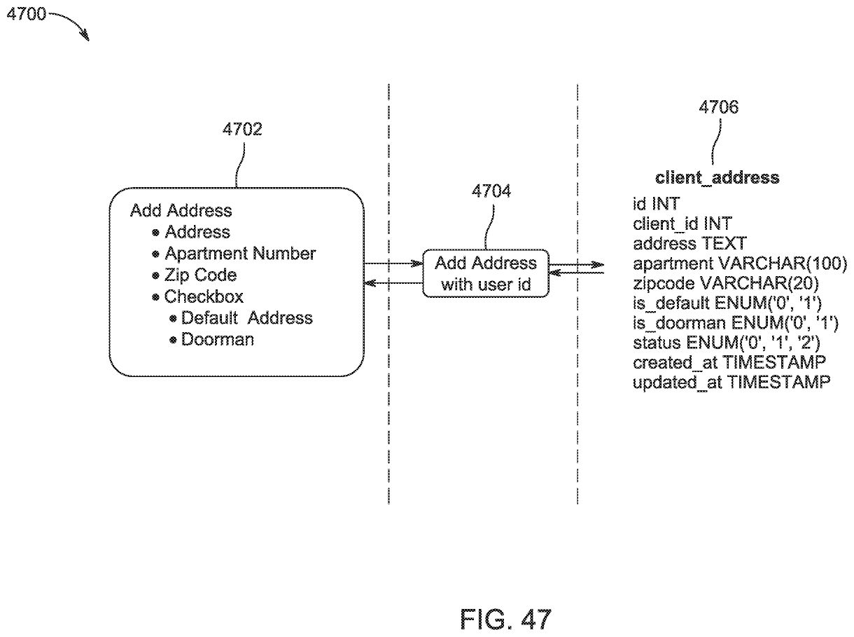

FIG. 47 depicts an illustration of a block diagram of an embodiment for adding address details to profile module 4700 for a system and method for dry cleaning and/or laundry logistics. At 4702, Address information is added. At 4704, an address is added with a user identifier. At 4706, client address details are created and generated with a timestamp.

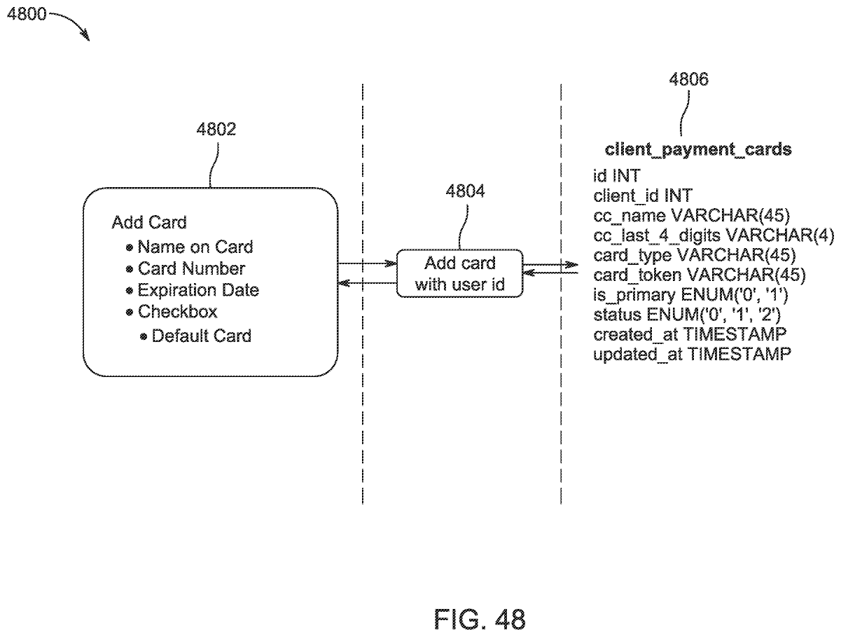

FIG. 48 depicts an illustration of a block diagram of an embodiment for adding card payment details to profile module 4800 for a system and method for dry cleaning and/or laundry logistics. At 4802, payment information is added. For example, card payment information is added. At 4804, card payment information is added with a user identifier. At 4806, client card payment details are created and generated with a timestamp.

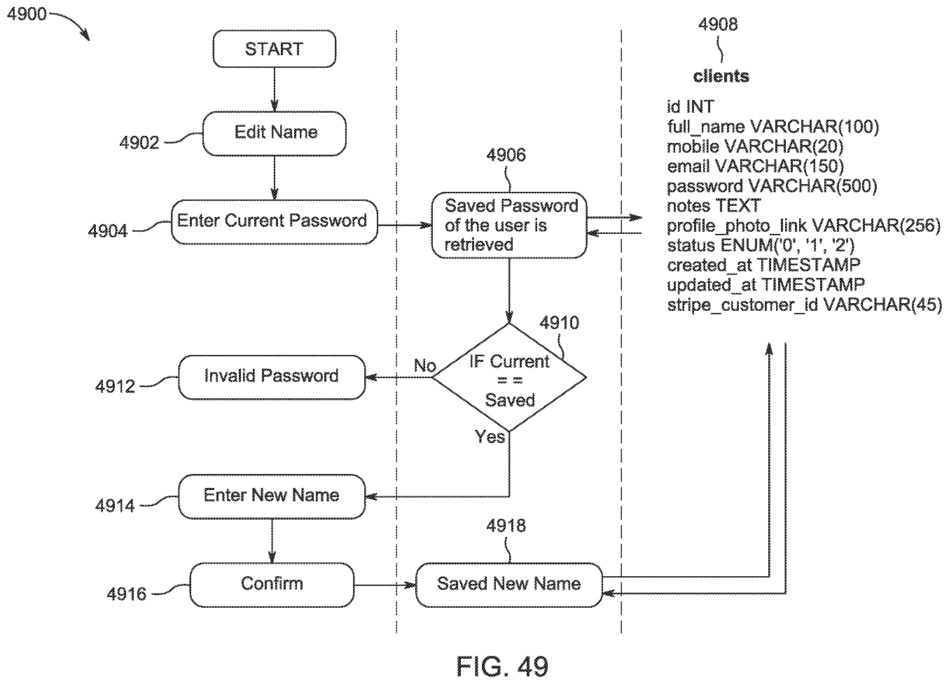

FIG. 49 depicts an illustration of a block diagram of an embodiment for editing personal details in profile module 4900 for a system and method for dry cleaning and/or laundry logistics. At 4902, a name is edited. At 4904, the current password is entered into the user interface. At 4906, the saved password of the associated user is retrieved. At 4908, client details are created and generated with a timestamp. At 4910, if the system detects that the currently entered password does not match a retrieved saved password, then the password is invalid at 4912. If the system detects that the currently entered password does match a retrieved saved password, then the password is valid and at 4914, a new name is entered in the webform by a user. At 4916, the user confirms the input data. At 4918, the new name is saved.

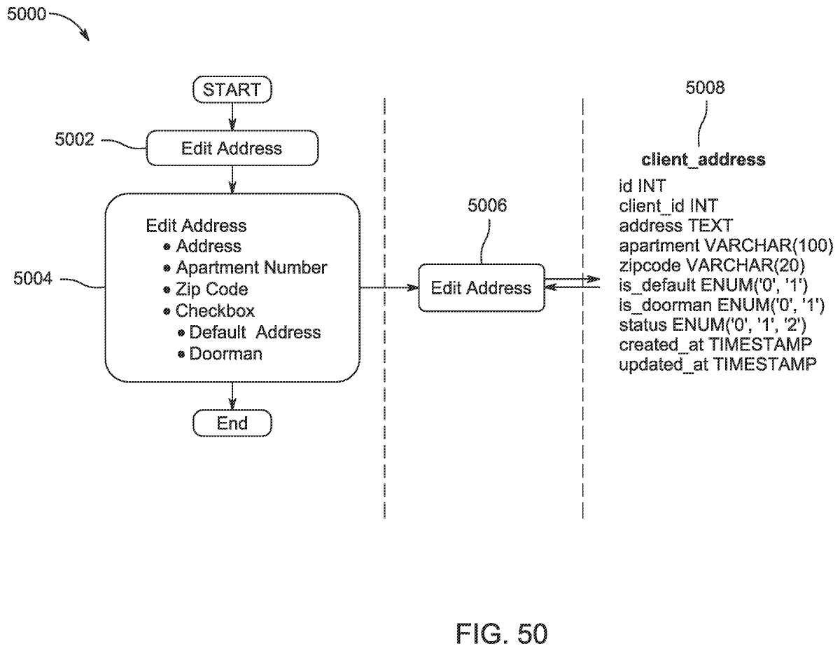

FIG. 50 depicts an illustration of a block diagram of an embodiment for editing address details in profile module 5000 for a system and method for dry cleaning and/or laundry logistics. At 5002, an address is edited. At 5004, editable address information includes, but is not limited to, address, apartment number, zip code, default address, and/or doorman information. At 5006, the address is edited and updated. At 5008, client address details are created and generated with a timestamp.

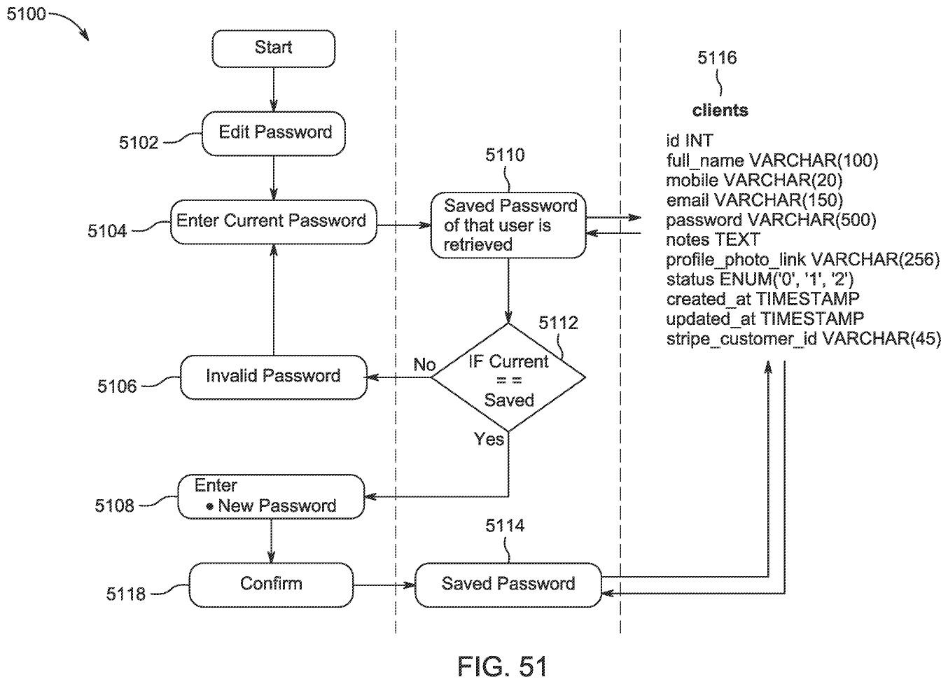

FIG. 51 depicts an illustration of a block diagram of an embodiment for editing password details in profile module 5100 for a system and method for dry cleaning and/or laundry logistics. At 5102, the password may be editable. At 5104, the current password is entered. At 5110, the saved password of the user is retrieved. At 5116, client details are created and generated with a timestamp. At 5112, if the system detects that the currently entered password does not match a retrieved saved password, then the password is invalid at S106. If the system detects that the currently entered password does match a retrieved saved password, then the password is valid and at 5108, a new password is entered in the webform by a user. At 5118, the user confirms the input data. At 5114, the new password is saved.

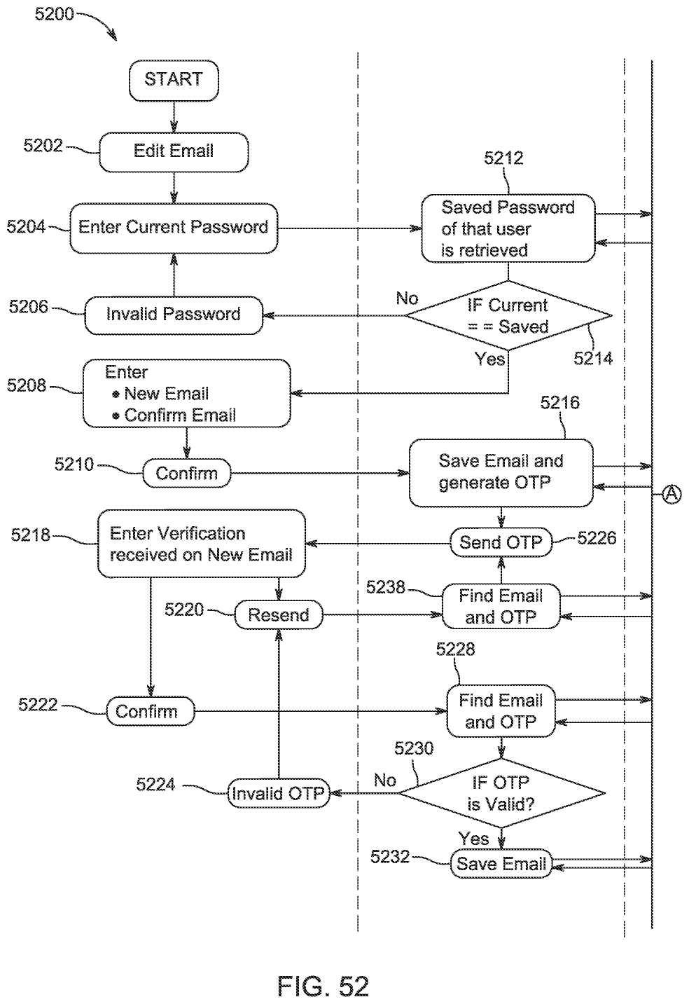

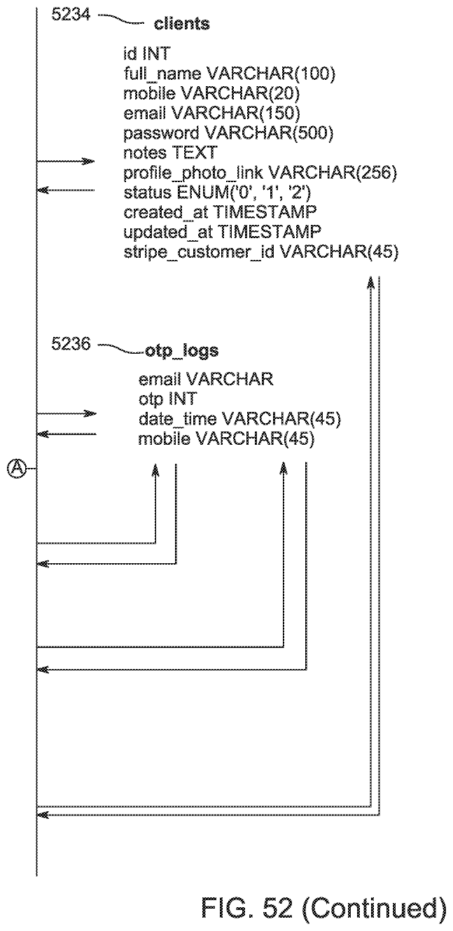

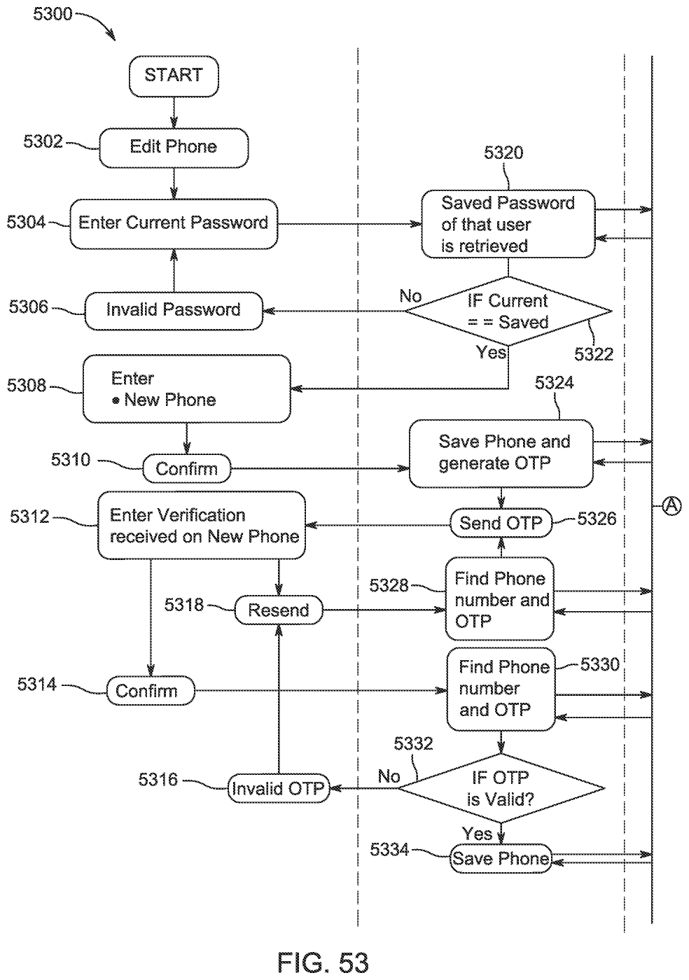

FIG. 52 depicts an illustration of a block diagram of an embodiment for editing email details in profile module 5200 for a system and method for dry cleaning and/or laundry logistics. At 5202, an email address is edited. At 5204, current password is entered. At 5212 the saved password of the user is retrieved. At 5234, client data is created and updated with a timestamp. At 5214, if the system detects that the currently entered password does not match a retrieved saved password, then the password is invalid at 5206. If the system detects that the currently entered password does match a retrieved saved password, then the password is valid and at 5208, a new email address is entered in the webform by a user. At 5210, the user confirms the input data. At 5216, the new email address is saved and an OTP is generated. At 5236, OTP log data is retained. At 5226, an OTP password is sent to the associated email address. At 5218, a user is prompted to enter the verification OTP received by the new email address. At 5220, the OTP code is resent. At 5238, the email address is found and the OTP is sent from the table. At 5222 the verification OTP is confirmed. At 5228, the email address is retrieved and the corresponding OTP. At 5230, the system determines if the OTP is valid. At 5224, the OTP is invalid. At 5232, the OTP is valid and the email address is saved.

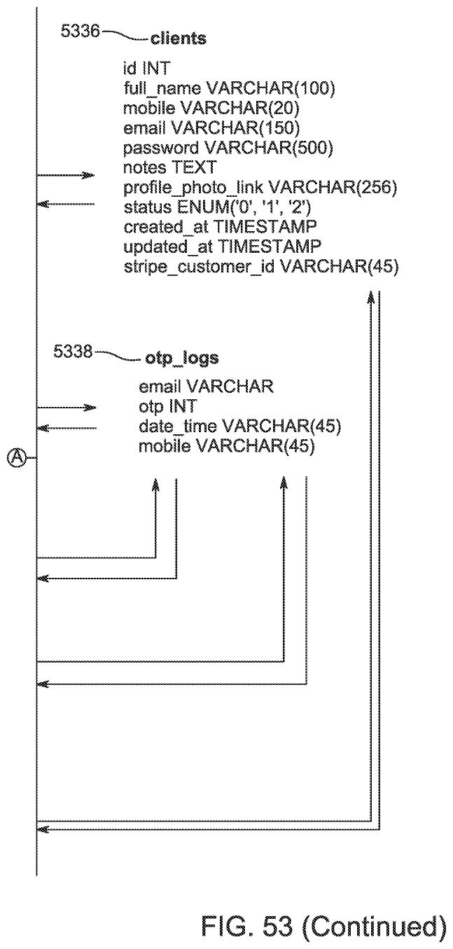

FIG. 53 depicts an illustration of a block diagram of an embodiment for editing mobile number details to profile module 5300 for a system and method for dry cleaning and/or laundry logistics. At 5302, a phone number is edited. At 5304, the current password is entered. At 5320 the saved password of the user is retrieved. At 5308, a new phone number is entered into the graphical user interface. At 5336, client data is created and updated with a timestamp. At 5322, if the system detects that the currently entered password does not match a retrieved saved password, then the password is invalid at 5306. If the system detects that the currently entered password does match a retrieved saved password, then the password is valid and at 5306, a new phone number is entered in the webform by a user. At 5310, the user confirms the input data. At 5324, the new phone number is saved and an OTP is generated. At 5338, OTP log data is retained. At 5326, an OTP password is sent to the associated phone number. At 5312, a user is prompted to enter the verification OTP received by the new email address. At 5318, the OTP code is resent. At 5328, the phone number is found and the OTP is sent from the table. At 5314 the verification OTP is confirmed. At 5328, the phone number is retrieved and the corresponding OTP. At 5330, the phone number is found by the system and an OTP is generated. At 5332, the system determines if the OTP is valid. At 5316, the OTP is invalid. At 5334, the OTP is valid and the email address is saved.

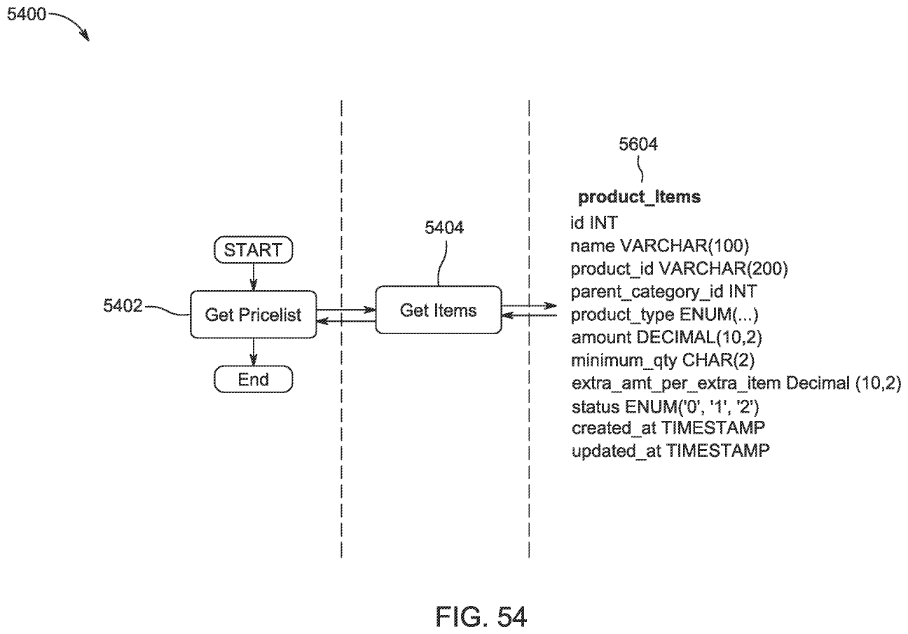

FIG. 54 depicts an illustration of a block diagram of an embodiment accessing price list data 5400 for a system and method for dry cleaning and/or laundry logistics. At 5402, a pricelist is retrieved. At 5404, items are retrieved. At 5406, product item data is created and updated with a timestamp.

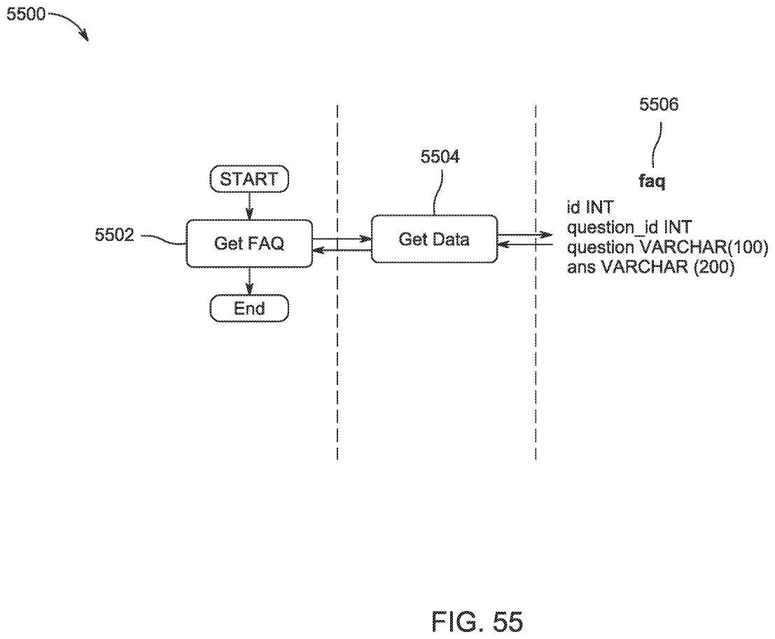

FIG. 55 depicts an illustration of a block diagram of an embodiment accessing informative data 5500 for a system and method for dry cleaning and/or laundry logistics. At 5502 read-only data is retrieved. At 5504, data such as question and answers, facts, information about a company, and/or information about products and/or services provided by a company is accessible to a user through a display accessing the application. At 5506, the data is retained and viewable.

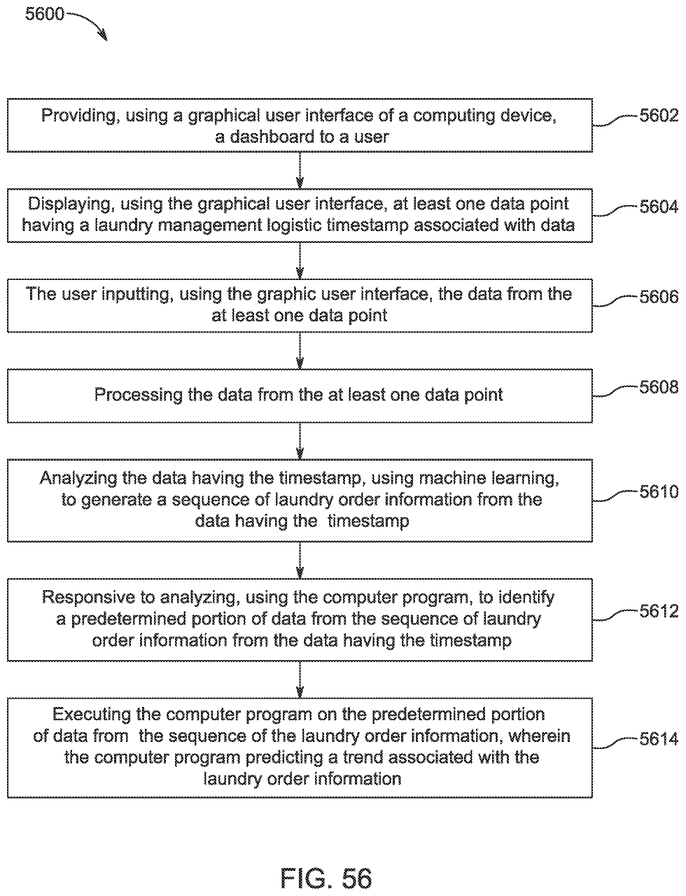

FIG. 56 depicts a flow chart illustrating method 5600 for dry cleaning and/or laundry logistic generation. At 5602, providing, using a graphical user interface of a computing device, a dashboard to a user. At 5604, displaying, using the graphical user interface, at least one data point having a laundry management logistic timestamp associated with data. At 5606, the user inputting, using the graphic user interface, the data from the at least one data point. At 5608, processing the data from the at least one data point. At 5610, analyzing the data having the timestamp, using machine learning, to generate a sequence of laundry order information from the data having the timestamp. At 5612, responsive to analyzing, using the computer program, to identify a predetermined portion of data from the sequence of laundry order information from the data having the timestamp. At 5614, executing the computer program on the predetermined portion of data from the sequence of the laundry order information, wherein the computer program predicting a trend associated with the laundry order information.

### Additional Information

A list or reports include, but are not limited to, orders, clients, dry cleaning, alterations, wash and fold, sign up, pay later, what is in store, pick-up, dropped off by customer, items to be delivered to the store, and/or items to be picked up by a customer. Each report is displayed in the list of columns in the application. The cards are displayed. The associated graph is displayed, search functionality and pagination to be added, the report is downloadable in Excel, the report is printable, and/or the data is sorted using a filter.

### Formulas for Reports

1. Monthly Average Order Value: Show the list of all reports on click on which individual reports should open Total revenue in that month/Total number of orders in that month such as: $21,000/1000=$21
2. Total number of orders placed by the customer from start till current date
3. Average Monthly Sale: Total revenue in that year/12 (number of months in one year)
4. Individual Report for every customer:
a. Number of orders placed
b. Percentage of items in the order
Example 1. Percentage of pants—Num of pants/Total num of items in that order*100
Example 2. Percentage of shirts—Num of shirts/Total num of items in that order*100
5. Total Revenue Orders—Total order price for current month
6. Unpaid Orders—Till date (From beginning till today)
7. Orders Today—Total paid+unpaid orders
8. New clients this month. (New signups) NOTE:
The aforementioned steps 5, 6, 7, and 8 are from a figma file.
Total Revenue Orders—Total Revenue Orders (in current month)
Unpaid Orders—Unpaid Orders (Till Date)
Orders Today—Orders Today (Paid+Unpaid)

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A computer program comprising instructions which, when the program is executed by a computer, cause the computer to carry out the steps of:
providing, using a graphical user interface of a computing device, a dashboard to a user;
displaying, using the graphical user interface, at least one data point having a laundry management logistic timestamp associated with data of an order;
inputting by the user, using the graphic user interface, the data from the at least one data point;
processing the data from the at least one data point;
analyzing the data having the timestamp, using machine learning, to generate a sequence of laundry order information from the data having the timestamp;
responsive to analyzing, using the computer program, to identify a predetermined portion of data from the sequence of laundry order information from the data having the timestamp; and
executing the computer program on the predetermined portion of data from the sequence of the laundry order information, wherein the computer program predicting a trend associated with the laundry order information.

2. The computer program of claim 1, further comprising generating, using the machine learning, a model of the trend.

3. The computer program of claim 1, further comprising displaying, using the graphical user interface, a graph having data associated with the trend for order rate.

4. The computer program of claim 1, further comprising displaying, using the graphical user interface, a graph having data associated with the trend for income.

5. The computer program of claim 1, further comprising displaying, using the graphical user interface, a graph having data associated with the trend for order frequency.

6. The computer program of claim 1, further comprising displaying, using the graphical user interface, a chart having data associated with the trend for a percentage calculated of a laundry order item for a predetermined time.

7. The computer program of claim 1, further comprising displaying, using the graphical user interface, a chart having data associated with the trend for a percentage calculated of a payment method used for a laundry order item.

8. The computer program of claim 1, further comprising generating, using a report module, a report.

9. The computer program of claim 8, wherein the report is an individual report for a customer based on a quantity of orders placed in a predetermined time period and a percentage of items in the order for the predetermined time period.

10. The computer program of claim 8, wherein the report is a monthly average order value report for the user based on a total revenue in a predetermined time period and a quantity of orders placed in the predetermined time period.

11. A computer-implemented method comprising:
providing, using a graphical user interface of a computing device, a dashboard to a user;
displaying, using the graphical user interface, at least one data point having a dry cleaning management logistic timestamp associated with data of an order;
inputting by a user, using the graphic user interface, the data from the at least one data point;
processing the data from the at least one data point;
analyzing, using the computing device, the data having the timestamp;
responsive to analyzing, using the computing device, identifying a sequence of dry cleaning order information from the data having the timestamp; and
executing the computing device on the sequence of the dry cleaning order information, wherein the computer predicting a trend associated with the dry cleaning order information.

12. The computer-implemented method of claim 11, further comprising displaying, using the graphical user interface, a graph having data associated with the trend for order rate.

13. The computer-implemented method of claim 11, further comprising displaying, using the graphical user interface, a graph having data associated with the trend for income.

14. The computer-implemented method of claim 11, further comprising displaying, using the graphical user interface, a graph having data associated with the trend for order frequency.

15. The computer-implemented method of claim 11, further comprising displaying, using the graphical user interface, a chart having data associated with the trend for a percentage calculated of a dry cleaning order item for a predetermined time.

16. The computer-implemented method of claim 11, further comprising displaying, using the graphical user interface, a chart having data associated with the trend for a percentage calculated of a payment method used for a dry cleaning order item.

17. The computer-implemented method of claim 11, further comprising generating, using a report module, a report.

18. The computer-implemented method of claim 17, wherein the report is an individual report for a customer based on a quantity of orders placed in a predetermined time period and a percentage of items in the order for the predetermined time period.

19. The computer-implemented method of claim 17, wherein the report is a monthly average order value report for a user based on a total revenue in a predetermined time period and a quantity of orders placed in the predetermined time period.

20. The computer-implemented method of claim 11, further comprising analyzing the data having the timestamp, using machine learning, to generate the sequence of laundry order information from the data having the timestamp.
